(19) United States
(12) Patent Application Publication
(10) Pub. No.: US 2014/0337756 A1
(43) Pub. Date: Nov. 13, 2014

(54) SYSTEMS AND METHODS FOR USER INTERACTION BASED ON LICENSE OR OTHER IDENTIFICATION INFORMATION

(71) Applicants: Frederick Mitchell THROWER, La Jolla, CA (US); Matt Kyle Clifford, La Jolla, CA (US); William Donald Rennie, San Diego, CA (US); John Sheldon Albers-Mead, San Diego, CA (US); Andrew Wayne Couch, San Diego, CA (US); Ashish Gupta, San Diego, CA (US); Kristina Anne Kenyon, San Diego, CA (US); Julia Nicole Metcalf, La Jolla, CA (US); Andrew Michael Phipps, La Jolla, CA (US); Fontaine Hanying Shu, San Diego, CA (US)

(72) Inventors: Frederick Mitchell THROWER, La Jolla, CA (US); Matt Kyle Clifford, La Jolla, CA (US); William Donald Rennie, San Diego, CA (US); John Sheldon Albers-Mead, San Diego, CA (US); Andrew Wayne Couch, San Diego, CA (US); Ashish Gupta, San Diego, CA (US); Kristina Anne Kenyon, San Diego, CA (US); Julia Nicole Metcalf, La Jolla, CA (US); Andrew Michael Phipps, La Jolla, CA (US); Fontaine Hanying Shu, San Diego, CA (US)

(21) Appl. No.: 14/089,648

(22) Filed: Nov. 25, 2013

Related U.S. Application Data
(63) Continuation of application No. 13/231,760, filed on Sep. 13, 2011, now abandoned.

(51) Int. Cl. H04L 29/06; G06F 3/0484; H04L 12/58

(52) U.S. Cl. CPC H04L 65/403; H04L 51/046; G06F 3/04842
USPC 715/752; 715/753

(57) ABSTRACT

Methods and systems for facilitating user interaction are described. One such method includes receiving, from a first user device, identification information associated with a targeted user and retrieving, from a database, contact information associated with the identification information. The method may further include providing the contact information to the first user device to facilitate communication between the first user device and a user device of the targeted user and/or providing a message to the user device of the targeted user.

### CROSS-REFERENCE TO RELATED APPLICATIONS

This application is a continuation of U.S. patent application Ser. No. 13/231,760, filed on Sep. 13, 2011. entitled SYSTEMS AND METHODS FOR USER INTERACTION BASED ON LICENSE OR REGISTRATION INFORMATION, which claims the benefit of priority under 35 U.S.C. §119(e) of U.S. Provisional Patent Application Ser. No. 61/382,442, entitled SYSTEMS AND METHODS FOR USER INTERACTION BASED ON LICENSE OR REGISTRATION INFORMATION, filed on Sep. 13, 2010, the contents of each of which are hereby incorporated by reference herein in their entirety for all purposes.

### FIELD

This application is directed generally to communications systems and associated social networking and user interaction. More particularly, but not exclusively, the application relates to systems and apparatus for allowing users to interact via wired or wireless communication systems using identification information such as, for example, license of registration information.

### BACKGROUND

Wireless communication systems are widely deployed to provide various types of communication content such as voice, data, video and the like. At the same time, social networking sites allow users to interact with one another. However, these sites typically require knowledge of users' names in order to allow interaction.

### SUMMARY

In one aspect the disclosure relates to a method for allowing a first user to interact with a second user including determining an identification criteria of the second user, sending a request, from a device associated with the first user to a server system, determining whether information is available about the second user, and providing, responsive to the determining, a communication to the second user.

The identification may be a license plate or other vehicle registration data or information. For example, the identification may be a license plate (registration) of a vehicle associated with the second user. In addition, the identification may include a region or jurisdiction associated with the license plate, such as a state, territory, province, country, district, region or other license designator.

The device associated with the first user may be a terminal or handset device, such as a cellphone, PDA, user equipment, portable computer or pad computer, or other device. The information may be captured by a camera or other optical sensing element of the user device, such as a cellphone camera or video camera. The information may be captured by the camera of the cellular phone and sent to the server system via a cellular connection, data connection, or other wired or wireless network connection such as a CDMA, GSM, LTE, Wi-Fi (802.11), Wi-Max, and/or other network connection.

The server system may comprise one or more servers or other computer systems, that may be integral or distributed. The server system may be configured to provide one or more modules for performing the various processes, methods, stages, steps and/or other functions as further described herein, which may be implemented in hardware, software, firmware or combinations of these. The server system may include or be connected to one or more databases on which application data and information, such as, for example, user information, license or registration information, and/or other information may be stored.

In another aspect, the disclosure relates to a method for processing information including receiving, from a device associated with a first user information including license or registration information, which may further include region or jurisdiction information such as state, territory, province, country, district, region or other license designators, and determining, based at least in part on the received information, user information associated with a second use.

The method may further include providing, to the first user, information associated with the second user. The method may further include providing, to the second user, information associated with the first user. Communication between the first and second user may be facilitated by directly or indirectly providing interconnections by, for example, direct communication, emails, text or voice messages, web pages, or via other communications methods.

In another aspect, the disclosure relates to a method for communicating with a targeted user including receiving, from a first user, license or registration information associated with the targeted user, and sending to the second user, based on the received license or registration information, a request to communicate from the first user. The request to communicate may further include information about or associated with the first user.

In another aspect, the disclosure relates to a method for facilitating user interaction. The method includes receiving, at first user device, identification information associated with a targeted user. The method further includes sending a request to communicate with the targeted user wherein the request includes the identification information. Contact information associated with the targeted user is then received responsive to the request.

In another aspect, the disclosure relates to a computer program product comprising a computer-readable medium including codes for causing a computer to receive identification information corresponding to a targeted user, send a request to communicate with the targeted user wherein the request includes the identification information, and receive, responsive to the request, contact information associated with the targeted user.

In another aspect, the disclosure relates to a communications device including a processing module configured to receive identification information corresponding to a targeted user. The device further includes a transmitter module configured to send a request to communicate with the targeted user wherein the request includes the identification information and a receiver module configured to receive, responsive to the request, contact information associated with the targeted user.

The disclosure also pertains to a method for facilitating user interaction. The method includes receiving, from a first user device, identification information associated with a targeted user and retrieving, from a database, contact information associated with the identification information. The method further includes providing the contact information to the first user device.

In yet another aspect, the disclosure relates to a computer program product comprising a computer-readable medium including codes for causing a computer to receive, from a first user device, identification information associated with a targeted user. The codes further includes codes for causing the computer to retrieve, from a database, contact information associated with the identification information and provide the contact information to the first user device.

In a further aspect the disclosure pertains to a system for facilitating user interaction which includes a receiver module configured to receive, from a first user device, identification information associated with a targeted user. The system also includes a processor module configured to search a database for contact information associated with the identification information and an output module configured to provide the contact information to the first user device.

Additional aspects, details, features and functions are further described below in conjunction with the appended drawings.

### BRIEF DESCRIPTION OF THE DRAWINGS

The present application may be more fully appreciated in connection with the following detailed description taken in conjunction with the accompanying drawings, wherein:

FIG. 1 illustrates details of a system on which various embodiments described herein may be implemented.

FIG. 2 illustrates details of an embodiment of a mobile device which may be, for example, one or both of mobile devices depicted in FIG. 1.

FIG. 3 which illustrates details of an embodiment of a server system, such as a server system shown in FIG. 1.

FIGS. 4-10 illustrate details of exemplary processes for facilitating user interaction.

FIGS. 11-26 illustrate details of embodiments of user interaction screens displayed by a client unit based upon information provided by, for example, a server system.

FIG. 27 illustrates details of embodiments of user screens and information such as may be provided on a mobile device using license or registration information.

FIG. 28 illustrates details of an embodiment of a user configuration screen which may be used to facilitate user configuration of settings.

FIG. 29 illustrates details of an embodiment of a display screen with example information that may be provided to a user, such as from other users.

FIG. 30 illustrates details of an embodiment of a display screen for sending a message to another user, which may be based on license or registration information.

FIG. 31 illustrates details of an embodiment of a display screen for acknowledging transmission of a message to another user.

FIG. 32 illustrates details of an embodiment of a display screen for sending a BUMP to a set of all users configured to receive messages or information.

FIG. 33 illustrates details of an embodiment of a display screen for setting user preferences.

FIG. 34 illustrates details of an embodiment of a display screen for configuring car settings.

FIG. 35 illustrates details of an embodiment of a display screen for setting a configuration without knowledge of a license or registration number.

FIGS. 36-80 illustrate exemplary use cases and embodiments of exemplary processing infrastructure capable of facilitating the corresponding user interaction.

### DETAILED DESCRIPTION

This disclosure relates generally to communications systems and associated social networking and user interaction, including systems and apparatus for allowing users to interact via wired or wireless communication systems using identification information such as license or registration information.

The identification may be a license plate or other vehicle registration data or information. For example, the identification may be a license plate (registration) of a vehicle associated with the second user. In addition, the identification may include a region or jurisdiction associated with the license plate, such as a state, territory, province, country, district, region or other license designator.

The device associated with the first user may be a terminal or handset device, such as a cellphone, PDA, user equipment, portable computer or pad computer, or other device. The information may be captured by a camera or other optical sensing element of the user device, such as a cellphone camera or video camera. The information may be captured by the camera of the cellular phone and sent to the server system via a cellular connection, data connection, or other wired or wireless network connection such as a CDMA, GSM, LTE, Wi-Fi (802.11), Wi-Max, and/or other network connection.

The server system may comprise one or more servers or other computer systems, that may be integral or distributed. The server system may be configured to provide one or more modules for performing the various processes, methods, stages, steps and/or other functions as further described herein, which may be implemented in hardware, software, firmware or combinations of these. The server system may include or be connected to one or more databases on which application data and information, such as, for example, user information, license or registration information, and/or other information may be stored.

In another aspect, the disclosure relates to a method for processing information including receiving, from a device associated with a first user information including license or registration information, which may further include region or jurisdiction information such as state, territory, province, country, district, region or other license designators, and determining, based at least in part on the received information, user information associated with a second use.

The method may further include providing, to the first user, information associated with the second user. The method may further include providing, to the second user, information associated with the first user. Communication between the first and second user may be facilitated by directly or indirectly providing interconnections by, for example, direct communication, emails, text or voice messages, web pages, or via other communications methods.

In another aspect, the disclosure relates to a method for communicating with a targeted user including receiving, from a first user, license or registration information associated with the targeted user, and sending to the second user, based on the received license or registration information, a request to communicate from the first user. The request to communicate may further include information about or associated with the first user.

In another aspect, the disclosure relates to a method for providing license-based user interaction including determining an identification of a targeted user using a mobile device, sending a request to communicate with the targeted user, and receiving, responsive to the request to communicate, information associated with the targeted user.

In another aspect, the disclosure relates to a computer program product comprising a computer-readable medium including codes for causing a computer to determine an identification of a targeted user using a mobile device, send a request to communicate with the targeted user, and receive, responsive to the request to communicate, information associated with the targeted user.

In another aspect, the disclosure relates to a communications device including a processing module configured to determine an identification of a targeted user using a mobile device, a transmitter module configured to send a request to communicate with the targeted user, and a receiver module configured to receive, responsive to the request to communicate, information associated with the targeted user.

In another aspect, the disclosure relates to a communications device including means for determining an identification of a targeted user using a mobile device, means for sending a request to communicate with the targeted user, and means for receiving, responsive to the request to communicate, information associated with the targeted user.

In another aspect, the disclosure relates to a method for providing license-based user interaction including receiving, at a server system, information associated with an identification of a targeted user, provided by a first user, searching a database for data associated with the targeted user based at least in part on the identification of the targeted user, and providing, responsive to the searching, information associated with the targeted user.

In another aspect, the disclosure relates to a computer program product comprising a computer-readable medium including codes for causing a computer to receive, at a server system, information associated with an identification of a targeted user, provided by a first user, search a database for data associated with the targeted user based at least in part on the identification of the targeted user, and provide, responsive to the searching, information associated with the targeted user.

In another aspect, the disclosure relates to a system for facilitating user interaction including a receiver module configured to receive, at a server system, information associated with an identification of a targeted user, provided by a first user, a processor module configured to search a database for data associated with the targeted user based at least in part on the identification of the targeted user, and an output module configured to provide, responsive to the searching, information associated with the targeted user.

In another aspect, the disclosure relates to a communications device including means for receiving, at a server system, information associated with an identification of a targeted user, provided by a first user, means for searching a database for data associated with the targeted user based at least in part on the identification of the targeted user, and means for providing, responsive to the searching, information associated with the targeted user.

Various other aspects and features of the disclosure are further described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

Social networking sites have grown dramatically over the past few years as online connectivity, such as through wired and wired cellular and Internet access has exploded. Many different classes and types of users have started using these sites as a way to connect with others, as well as talk about and show what they are doing. However, existing social networking sites typically require that users know the names or other information about other they wish to connect and communicate with. This approach requires that social networking sites provide user name searches, or in some cases searches based on a user's face or other personal information.

At the same time, use of cellular phones and other terminal devices (also referred to generally herein as “mobile devices” or “terminals”) has exploded, and with this explosion new features and functions are constantly being added. One feature that is becoming ubiquitous on cell phones, PDAs, pads, and other mobile devices is a camera. Cameras on these user devices support still photography, as well as, in some cases video capture. A user may use a camera to capture a photo of a person, thing, or other information and then upload, from their mobile device, still images and/or video to social networking sites as well as directly to other users, such as friends, family members, and the like.

In accordance with one aspect, a user may be provided with an application on their mobile device to capture an image, such as a license plate or registration information of a vehicle and then send that information to a server system for further processing. For example, a user may use their mobile device to take a picture of another person's vehicle license, which may include a license or registration number, and/or additional information, such as a state, territory, province, or other region or jurisdiction associated with the license or registration.

Upon receipt at the server system, the information may then be processed to determine whether the license or registration information is associated with another user (also denoted herein as a targeted user). If the targeted user has established an account with the server system, a message or other communication may be sent to the targeted user. If no account has been established with the targeted user, their license or registration information may be saved or stored in a database coupled with the server system for future communications. Alternately or in addition, a database of license information and associated registrant information may be collected, such as from motor vehicle registration authorities, public or private databases, or other sources of information. The associated registrant information may include one or more phone numbers, addresses, email addresses, websites, social network userids, and/or other identification information. In this case, even if the registrant does not have an account associated with the server system, a message may be sent to the registrant based on the received license information.

As one example, if a first user is driving and notices a vehicle that is for sale, or has a problem (such as a low tire, etc.) the first user may capture an image of the license information (i.e., license tag) on the vehicle (where the vehicle is associated with a second or target user, such as through the second user's Department of Motor Vehicles (DMV) registration) and send the captured license information, for example in the form of a still image or video of the second user's license tag, to the server system. In addition, the first user may send a message along with the captured image or video, such as a phone number and an interest in buying the vehicle, or a message that the tire air pressure is low).

Upon receipt at the server system, a search of a database may be done to determine whether the second user has an account associated with the server system. For example, the first and second user may have registered or signed up for an account with a server system service, which in one example may be denoted as “Bump,” for a server system provided by Bump Network, assignee of this application. If the second user has an account associated with the server system, a message may be sent to the second user. The message may be in the form of a text message, email, voice message, or other communication.

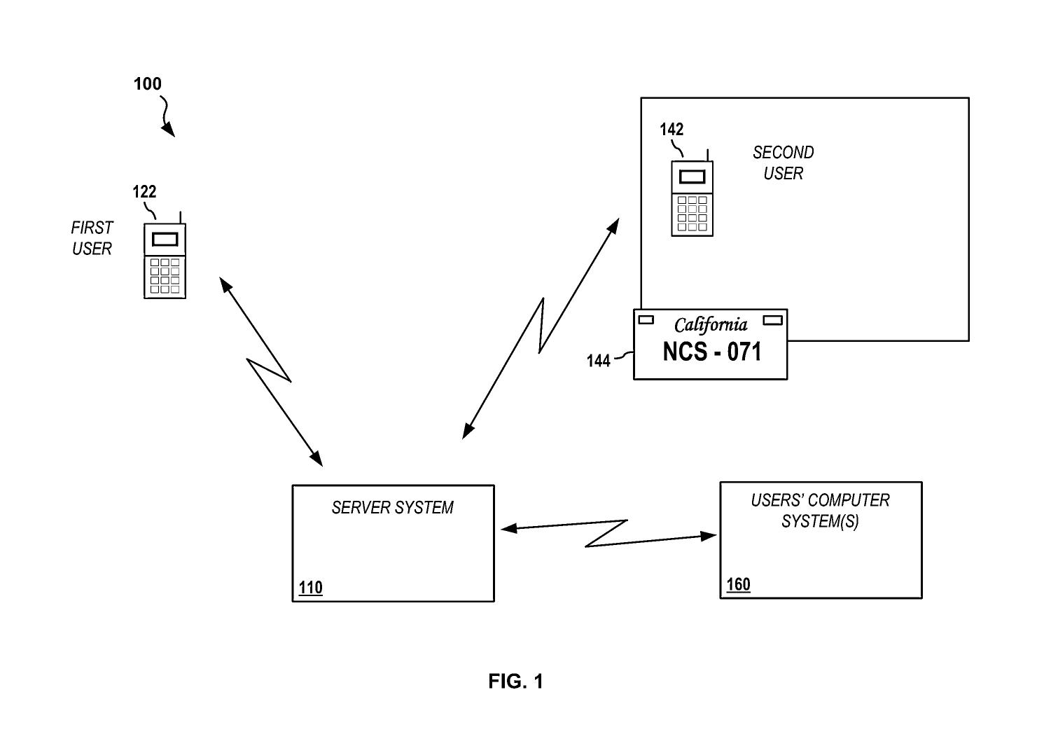

Attention is now directed to FIG. 1, which illustrates details of a system 100 on which various embodiments may be implemented. System 100 includes a server system 110 (which may also be denoted herein as a central server system or central system), as well as a mobile device 122 associated with a first user and a terminal device 142 associated with a second or targeted user. Various other elements (not shown) may be included in system 100, including multiple other users and their associated mobile (or fixed) devices, as well as other interconnected systems, such as databases, record storage sites or data warehouses, systems associated with other social networking sites such as Facebook, MySpace, and the like, systems associated with organization that maintain vehicle license or registration information such as state motor vehicle agencies, similar or equivalent private organizations, and the like.

The second user will generally have a license or registration associated with a vehicle, such as example license plate 144 shown in FIG. 1. The license plate typically includes an alphanumeric number as well as a state or other jurisdiction (for example, in FIG. 1, the number is NCS-071 and the state is California).

In addition, server system 110 may include an interface to allow users to connect to it for sending or receiving messages, configuring user accounts, and/or performing other user and/or administrative functions. This may be done through an interface providing connectivity between server system 110 and one or more of the users' computer systems 160 as shown in FIG. 1.

In operation, system 100 allows the first user to communicate, such as via an associated mobile device like a cellular phone, PDA, or other device, to the server system 110 with information associated with a targeted second user. For example, the first user may capture and send the information on the second user's license plate 144, and send that information to the server system 110 along with a request to communicate or interact with the second user. This communication may be done directly through the second user's mobile device 142, and/or may be done through a computer 160 associated with the second user. In some implementations, the message may be stored in the server system 110 until such time as the second user creates an account or otherwise interacts with server system 110, such as by accessing a web page provided by or from server system 110.

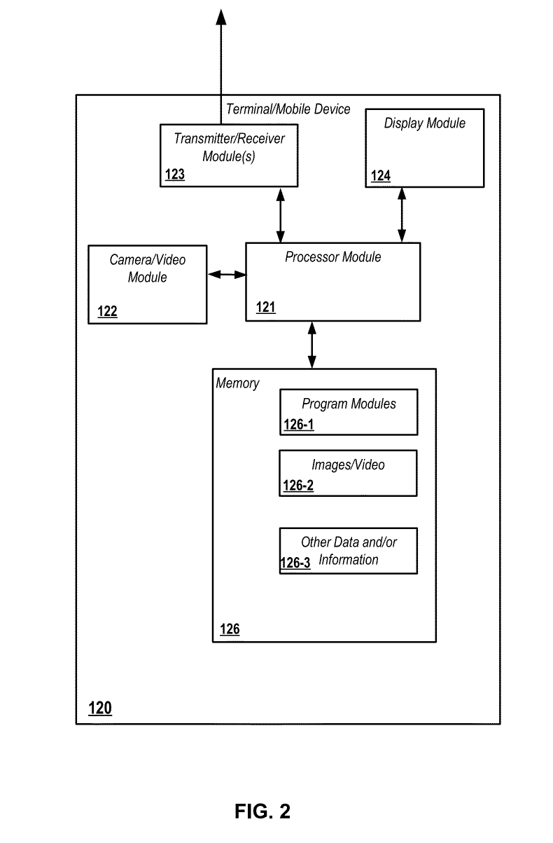

FIG. 2 illustrates details of an embodiment of a mobile device 120, which may be, for example, one or both of mobile devices 120, 142 as shown in FIG. 1. In an exemplary embodiment, mobile device 120 includes one or more application programs that implement the various mobile device functions as further described herein. The application program may be in the form of a computer readable medium including instructions for execution on one or more processors of the mobile device, such as processor module 121. The instructions may be stored in a memory 126 of the mobile device, and corresponding display and interaction screens may be presented on display module 124. A transmitter/receiver module 123 may be included to provide connectivity between mobile device 120 and a server system, such as server 110 of FIG. 1. In addition, a camera/video module 122 may be included in mobile device 120. The application program(s) may use the camera module to capture images or video, such as images or video of targeted users' license plate information and/or other information. The application programs may further include modules configured to process the images to generate information such as the license number and/or state or other jurisdiction shown on the license plate. Alternately or in addition, this information may be input by a user. The information may then be sent to the server system, where additional processing may be done.

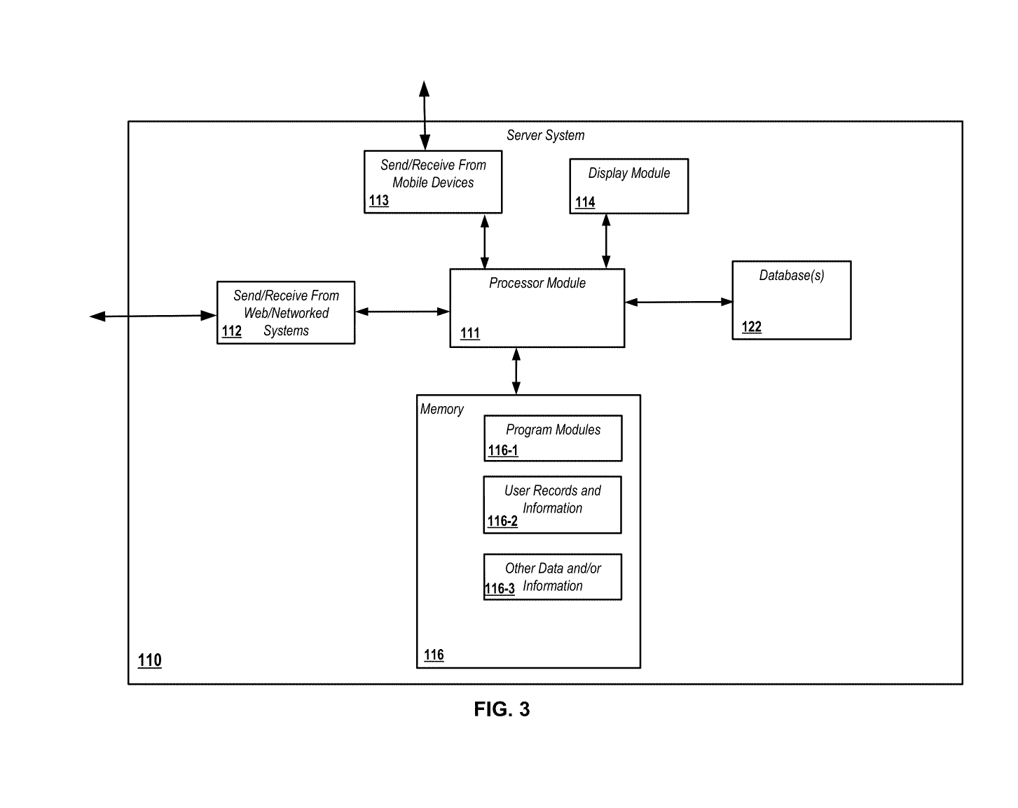

Attention is now directed to FIG. 3, which illustrates details of an embodiment of a server system, such as server system 110 as shown in FIG. 1. System 110 may include a processor module 111 and associated program modules 116-1 configured to perform the various functions as described further herein. In addition, server system 110 may include one or more display modules 114, one or more send/receive modules configured to send and/or receive information from users, such as from the users' computer systems. In addition, server system 110 may include a send/receive module 113 configured to send and/or receive information to users, such as through their mobile devices, such as device 120 as shown in FIG. 2.

Program modules 116-1 may include modules to facilitate user creation of account, searching for users based on information, such as license or registration information, character recognition to determine targeted user information from license plates or other identification information, as well as to perform other functions, processes and methods as described herein.

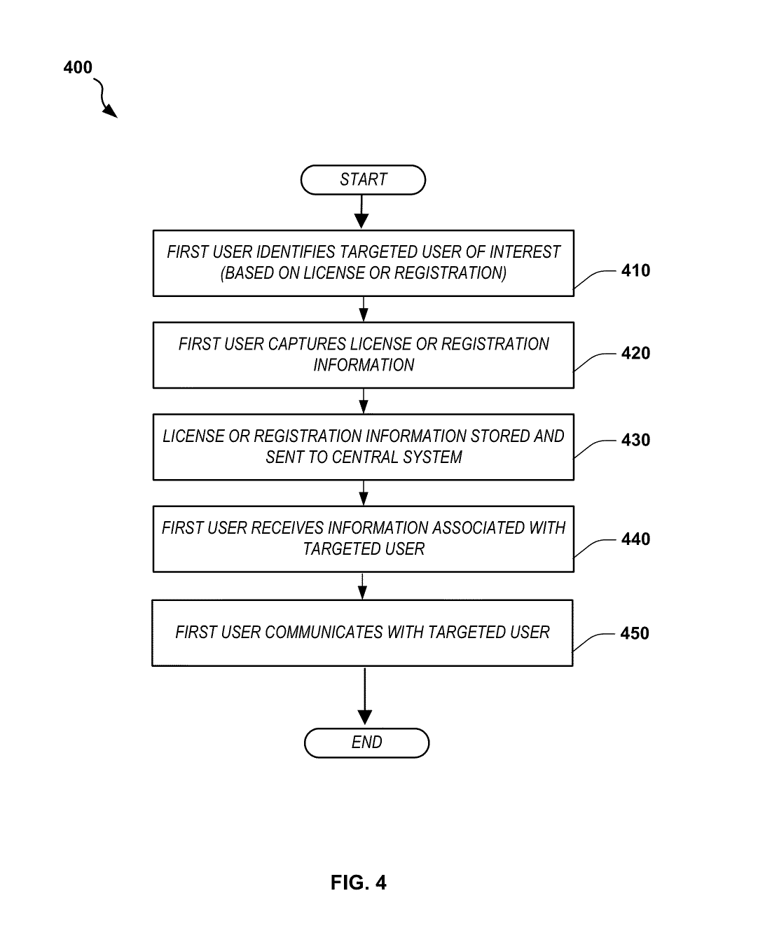

Attention is now directed to FIG. 4, which illustrates details of an embodiment of an example process 400 for facilitating user interaction. At stage 410, a first user may identify a targeted user of interest, such as an unknown person driving in another vehicle. The identification may be based on the vehicle's license or registration information, which may be on a license plate. At stage 420, the first user may capture that information, such as by writing it down, entering into a device such as a cellular phone, and/or capturing it, such as by taking a photo or video of the license plate. This may be done by or in conjunction with an application program running on the first user's mobile device. At stage 430, the information may be saved locally on the user's device and/or sent to a server system for further processing to facilitate identification and contacting of the targeted user. If the targeted user can be identified by the server system, such as, for example, if the targeted user has an account with the server system, the targeted user's license or registration information may be retrieved from a database from the server system, or the targeted user may be otherwise identified. Contact or other information associated with the targeted user may then be sent to the first user (stage 440). This may be done by, for example, sending an email, text or voice message, on a web page, or by utilizing other communication methods as known or developed in the art.

Assuming a connection can be made, the first user may then send a communication to the targeted user at stage 450, such as, for example, from the first user's mobile device to a mobile device associated with the second user.

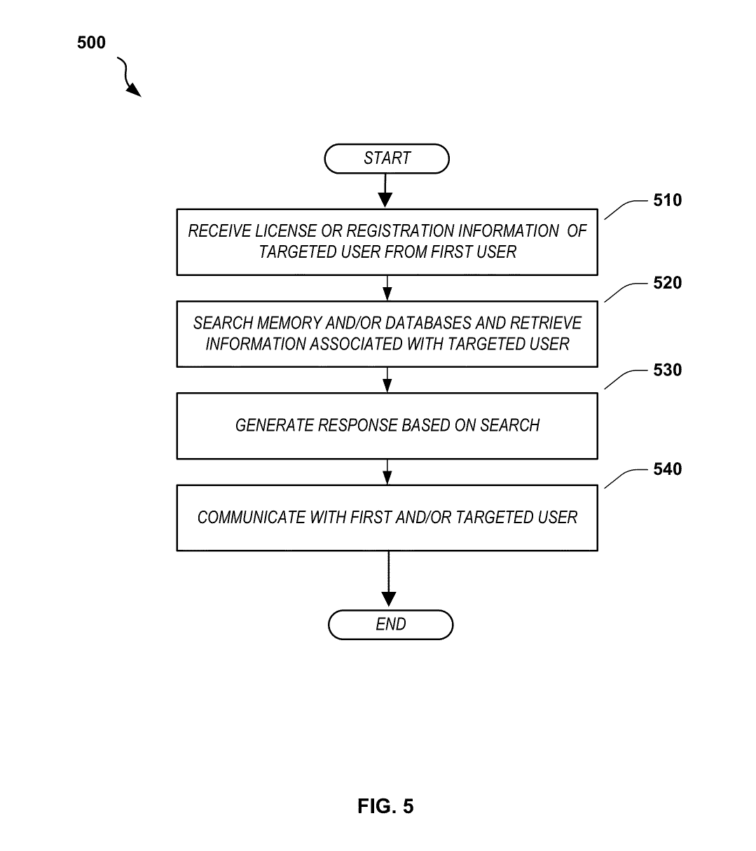

Attention is now directed to FIG. 5, which illustrates details of an embodiment of an example process 500 for facilitating user interaction. At stage 510, information may be received from a first user, where the information may be associated with a targeted or second user. The information may be provided from a mobile device associated with the first user and may be received at a server system. At stage 520, memory and/or one or more databases may be searched for information related to the targeted user, where the searching may be done based at least in part on the received information, such as license or registration information. The information may be extracted from an object, such as an image or video file, such as by optical character recognition or other recognition techniques.

At stage 530, a response may be generated based on the search. For example, a message or communication may be provided to the first and/or targeted user. The message may be accessible through an account associated with one or both users, and may allow the user to filter or screen messages from other users, as well as perform other operational, administrative, and/or maintenance functions. At stage 540, dependent on the search and messaging, a communication may be initiated between the first and targeted user. For example, the first user may wish to make a telephone call to the targeted user, and the server system may provide contact information and/or initiate and/or process the communication.

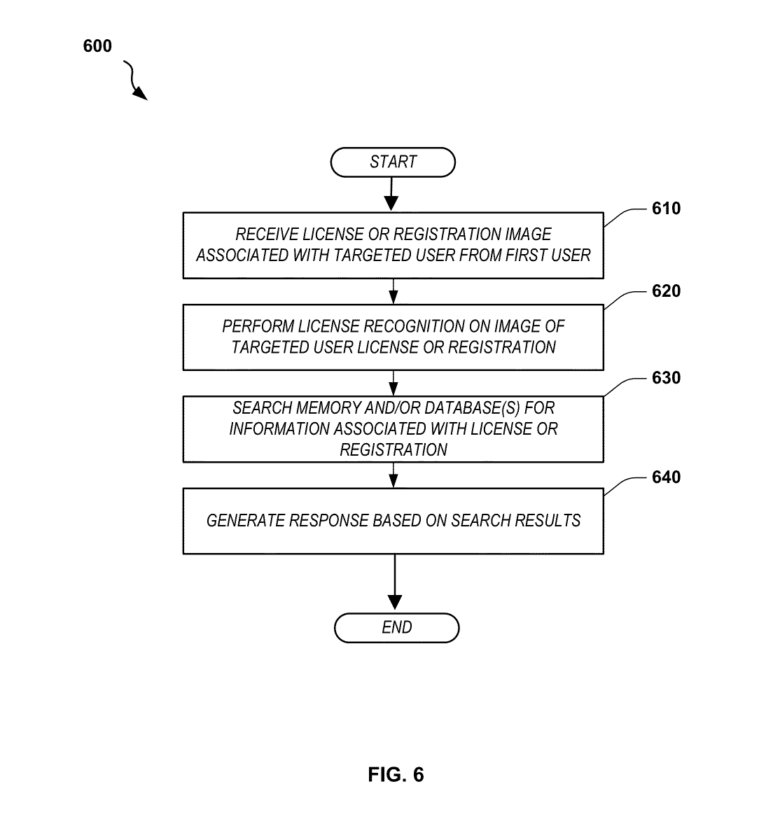

FIG. 6 illustrates details of an embodiment of an example process 600 for facilitating user interaction. At stage 610, a license or registration image or video may be received, for example, at a server system. The image may be processed at stage 620 to determine information, such as the license or registration number, jurisdiction, and/or other identification information associated with a targeted user. At stage 630, based on the recognition processing, a search may be performed in memory and/or one or more databases for contact information associated with the targeted user. At stage 640, a response, such as a message, email, voice message, web page, or other response may be generated and provided to the first user and/or the targeted user. For example, an email address of the targeted user may be provided to the first user.

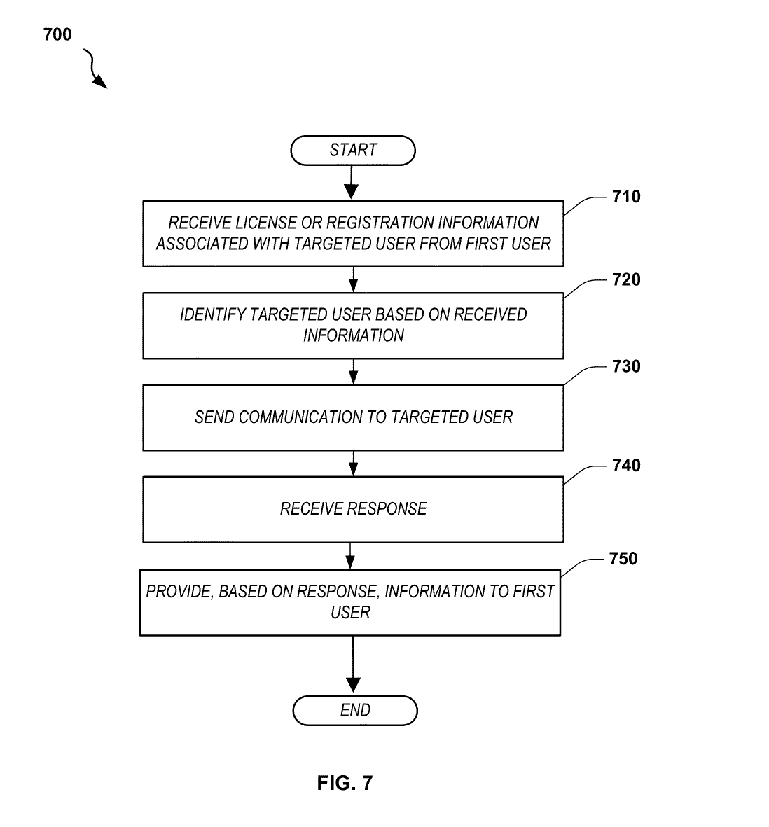

FIG. 7 illustrates details of an embodiment of an example process 700 for facilitating user interaction. At stage 710, license or registration information associated with a targeted user may be received from a first user. At stage 720, the targeted user may be identified, such as based on the received license or registration information. At stage 730, a message may be sent, such as from a server system, to the targeted user. The message may be, for example, a text message, email message, voice message, web page with accessible message information, or via other communication methods. Based on the targeted user's interest, he or she may choose to respond or may decline, or may wish to receive further information. The targeted user may send a response, which may be received at stage 740. Depending on the response, information may be sent to the first user (stage 750). Such information may comprise, for example, contact information for the targeted user, a link to a messaging forum, or other information that may be used to facilitate interaction between the first and targeted users.

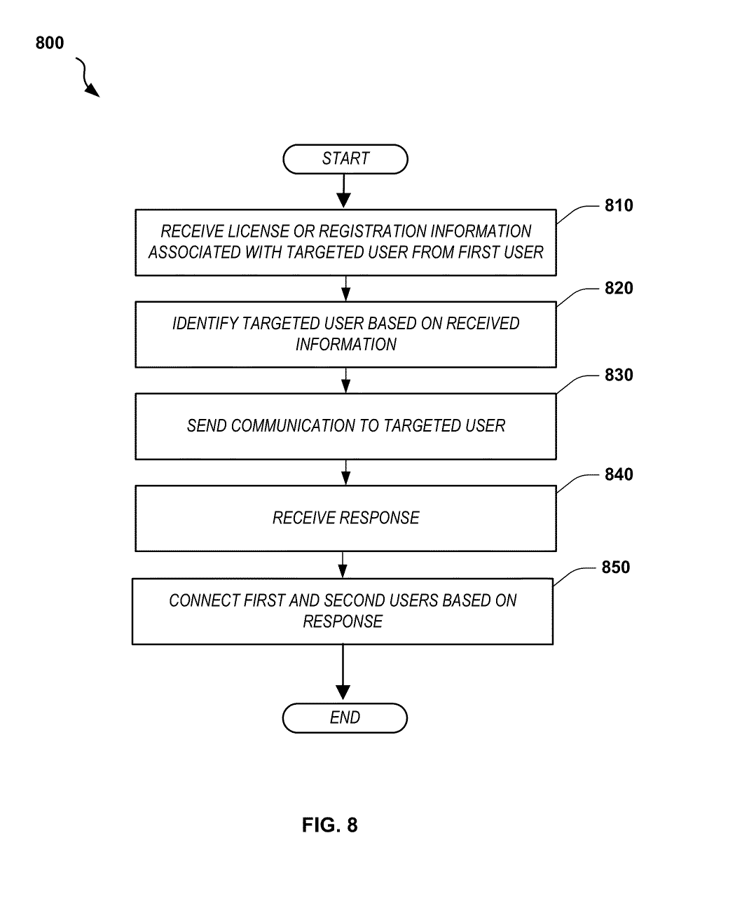

FIG. 8 illustrates details of an embodiment of an example process 800 for facilitating user interaction. At stage 810, license or registration information associated with a targeted user may be received from a first user. At stage 820, the targeted user may be identified, such as based on the received license or registration information. At stage 830, a message may be sent, such as from a server system, to the targeted user. The message may comprise, for example, a text message, email message, voice message, or a web page with accessible message information. Based on the targeted user's interest, he or she may choose to respond or may decline, or may wish to receive further information. The targeted user may send a response, which may be received at stage 840. Depending on the response, a connection may be established between the first and second users at stage 850, such as via the exchange of email or text messages, through voice communication, text, or via other communication methods.

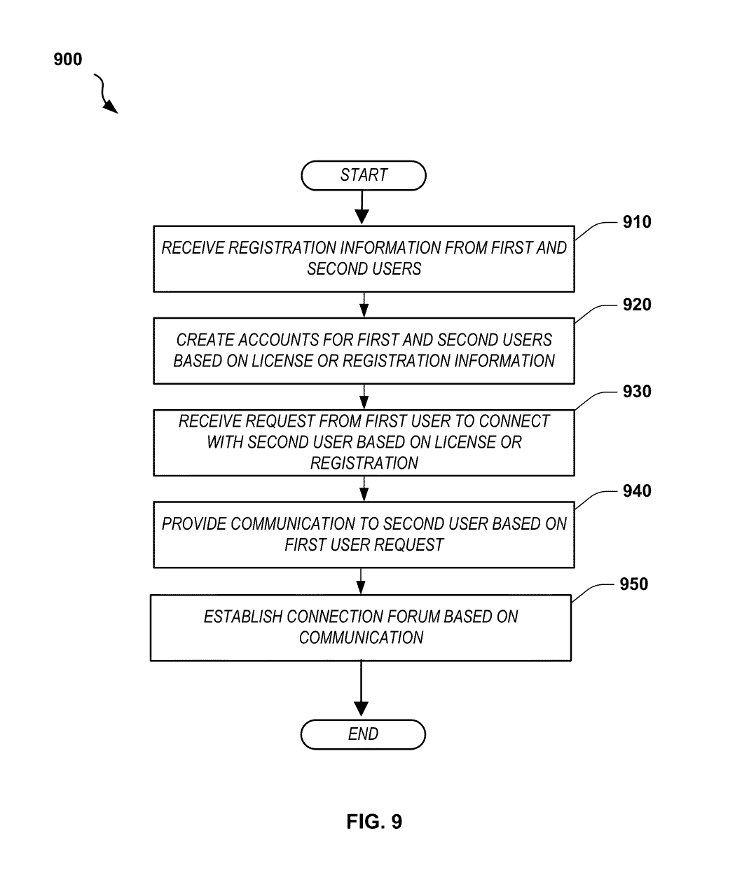

Attention is now directed to FIG. 9, which illustrates details of an embodiment of an example process 900 for facilitating interaction between first and second users. At stage 910, registration information may be received from the first and second users, such as, for example, is illustrated subsequently herein. At stage 920, accounts may be created for the first and second users, which may be based at least in part on the users' license or registration information. Alternately or in addition, the users may be provided with an interface to “claim” their registrations, which may be stored based on the license or registration number in a memory or database.

At stage 930, a request may be received from the first user to connect with the second user, such as based on license or registration information. In response to the request, a communication may be made to the second user requesting permission to initiate a communication with the first user. This may be done by, for example, through an email or text message, a voice message, a web page, or through other communication methods. At stage 950, based at least in part on the second user's response, a communication session may be established between the first and second users.

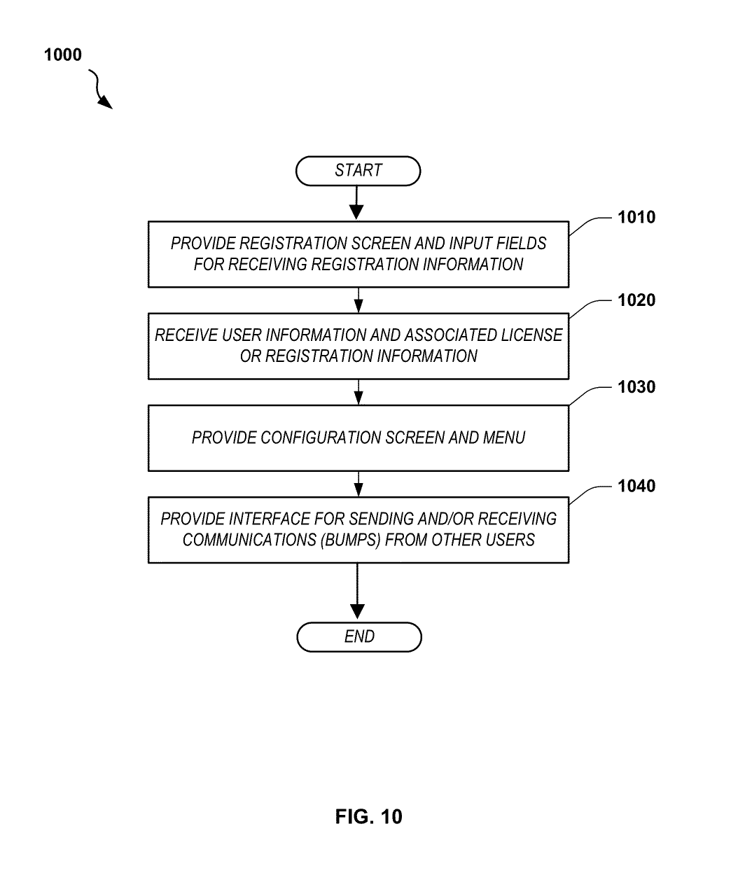

Attention is now directed to FIG. 10, which illustrates details of an embodiment of an example process 1000 for facilitating user registration. At stage 1010, a registration display or screen may be provided to allow a user to enter information, such as name, address, email information, phone information, and/or other user identification information. In addition, the user may be provided with an option to enter or “claim” a license or registration. At stage 102, the user's information is received and may be stored in a memory or database, such as in a server system. At stage 1030, a configuration screen may be provided, wherein the configuration screen may include options to allow a user to select various criteria for facilitating interaction and communication with other users. Once the user configuration is completed, an interface may be provided at stage 1040 to facilitate user communication with other users, such as to send or receive communications (“BUMPs”) or otherwise interact.

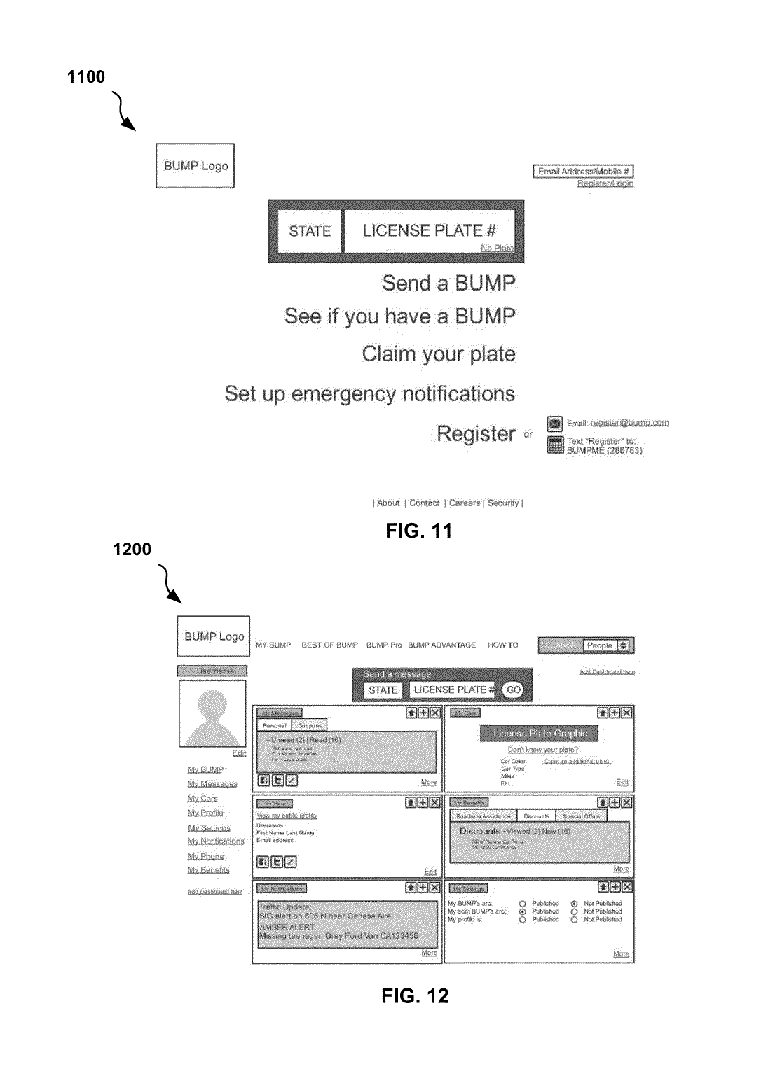

Attention is now directed to FIG. 11, which illustrates details of an embodiment of a user interaction screen 1100 which may be generated on the basis of, for example, information provided by a server system. The user interaction screen may be generated by, and displayed upon, a user's mobile device, a desktop or mobile computer, or on another display device, such as an in-vehicle interactive display. Screen 1100 may be configured to allow a user to enter information for providing a message to a second or targeted user (also denoted herein as a “BUMP” based on a particular implementation provided by Bump Network). In particular, screen 1100 may include options for allowing a user to register, claim a license plate, such as a license or registration associated with the user, set up emergency notifications, receive messages from other users (e.g., BUMPs), as well as send BUMPs to other users. In an exemplary embodiment the communications respectively corresponding to each of these options may be based on vehicle license or registration information associated with the other user.

FIG. 12 illustrates details of an embodiment of a user interaction screen 1200 which may be based upon information provided by, for example, a server system and displayed by a client unit (e.g., by a mobile communication device, a desktop or mobile computer, or by another display device such as an in-vehicle interactive display).

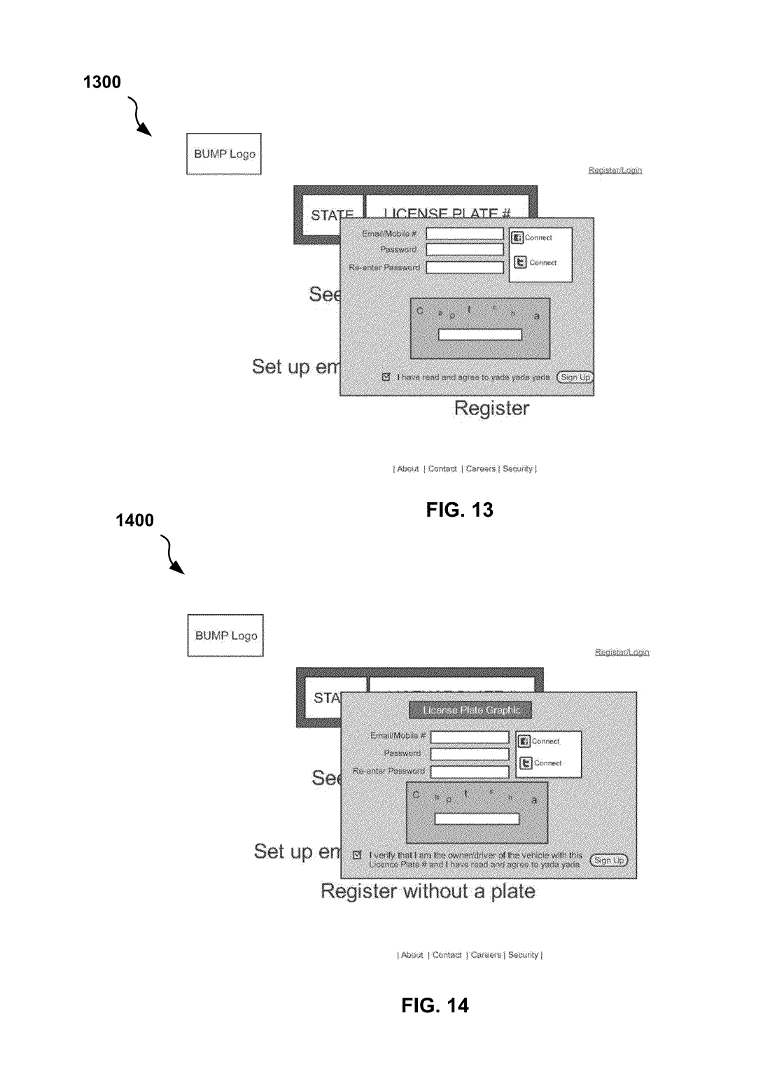

FIG. 13 illustrates details of an embodiment of a user interaction screen 1300, which may be further based on an interaction screen such as is shown in FIG. 11. Screen 1300 may include options to allow a user to access a system for communicating using information such as licenses or registrations, which may be on a server system.

FIG. 14 illustrates details of an embodiment of a user interaction screen 1400 which may be further based on an interaction screen such as is shown in FIG. 11. Screen 1400 may include options to allow a user to access a system for communicating using information such as licenses or registrations. Such information may be stored on or accessible to a server system and may comprise, for example, a license plate graphic or other graphic or alphanumeric information associated with a user's license or registration and/or the license or registration of a targeted user of interest.

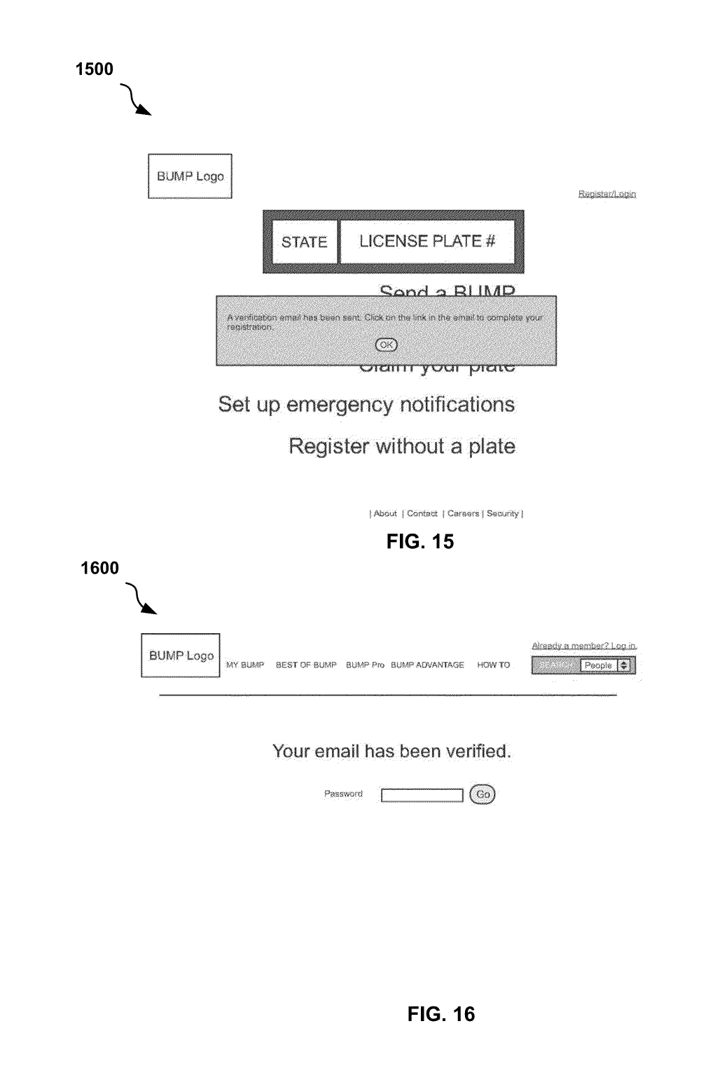

FIG. 15 illustrates details of an embodiment of a user interaction screen 1500 which may be further based on an interaction screen such as is shown in FIG. 11. Screen 1500 may include options to allow a user to access a system for communicating using information such as licenses or registrations, which may be stored on or accessible to a server system. The information may be related to a registration and associated verification process, such as a response to an email message sent to a user.

FIG. 16 illustrates details of an embodiment of a user interaction screen 1600, which may be further based on an interaction screen such as is shown in FIG. 11. Screen 1600 may include options to allow a user to access a system (e.g., a server system) for communicating using information such as licenses or registrations. In the exemplary illustration of FIG. 16 the information may be related to a confirmation message.

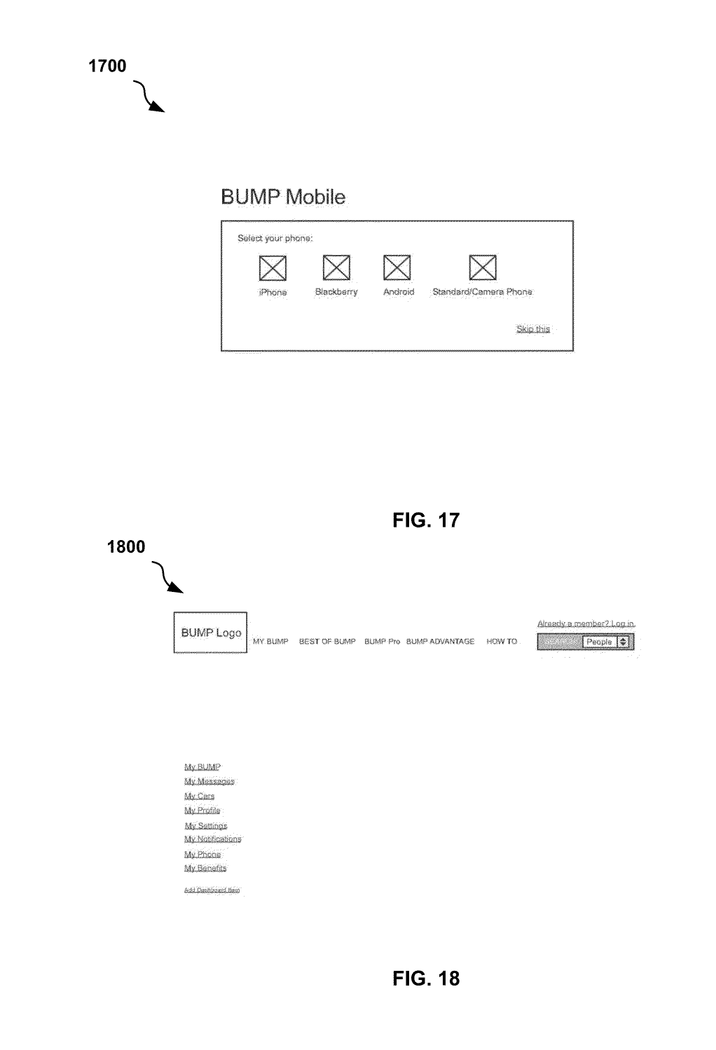

FIG. 17 illustrates details of an embodiment of a user interaction screen 1700 which may be used by a user to set up configuration information such as the user's type of phone, and/or other related parameters (not shown).

FIG. 18 illustrates details of an embodiment of a user interaction screen 1800 which may be used by a user to access information related to sent and/or received BUMPs, such as on a mobile device.

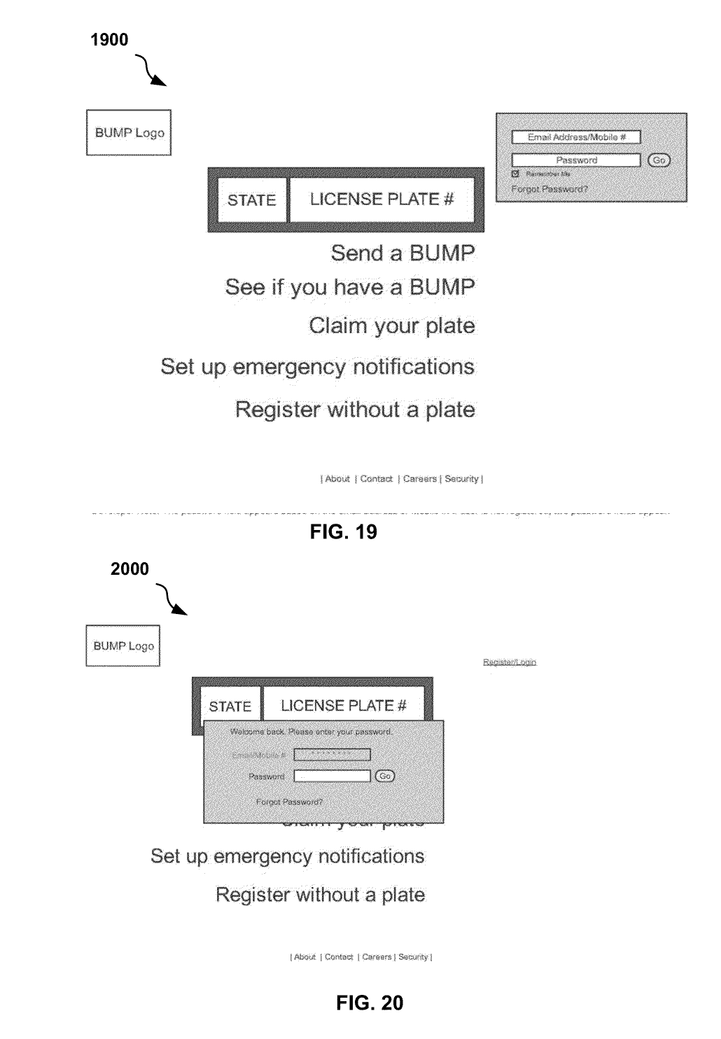

FIG. 19 illustrates details of an embodiment of a user interaction screen 1900 which may be used by a user to access information related to sent and/or received BUMPs, such as on a mobile device.

FIG. 20 illustrates details of an embodiment of a user interaction screen 2000 which may be used by a user to access information related to sent and/or received BUMPs, such as on a mobile device by logging onto an existing account.

FIG. 21 illustrates details of an embodiment of a user interaction screen 2100 which may be used by a user to access information related to sent and/or received BUMPs (e.g., BUMPs sent to the user by another user). The BUMPs may be sent to the other user based on license or registration information associated with the user. In some implementations, a user may not have yet claimed his or her plate (i.e., associated his or her account with license or registration information and/or associated jurisdictional information, such as a state, territory, province, district, country, etc.). In this case, an additional option may be provided to allow the user to claim his or her plate, which may include providing verification information.

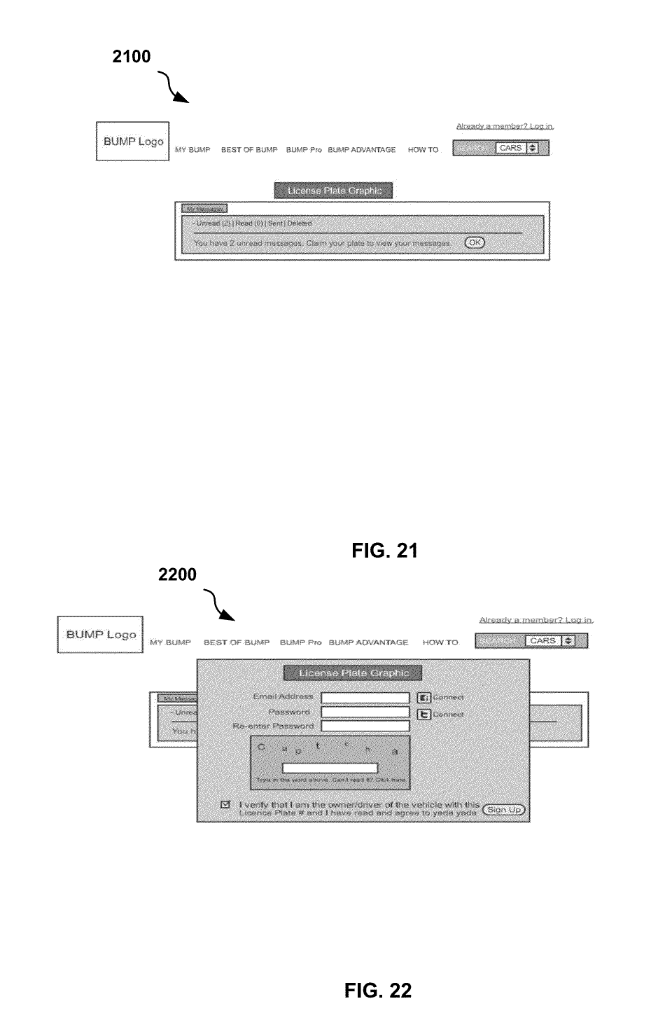

FIG. 22 illustrates details of an embodiment of a user interaction screen 2200 which may be used by a user to verify information such as may be provided through an interface screen as shown in FIG. 21.

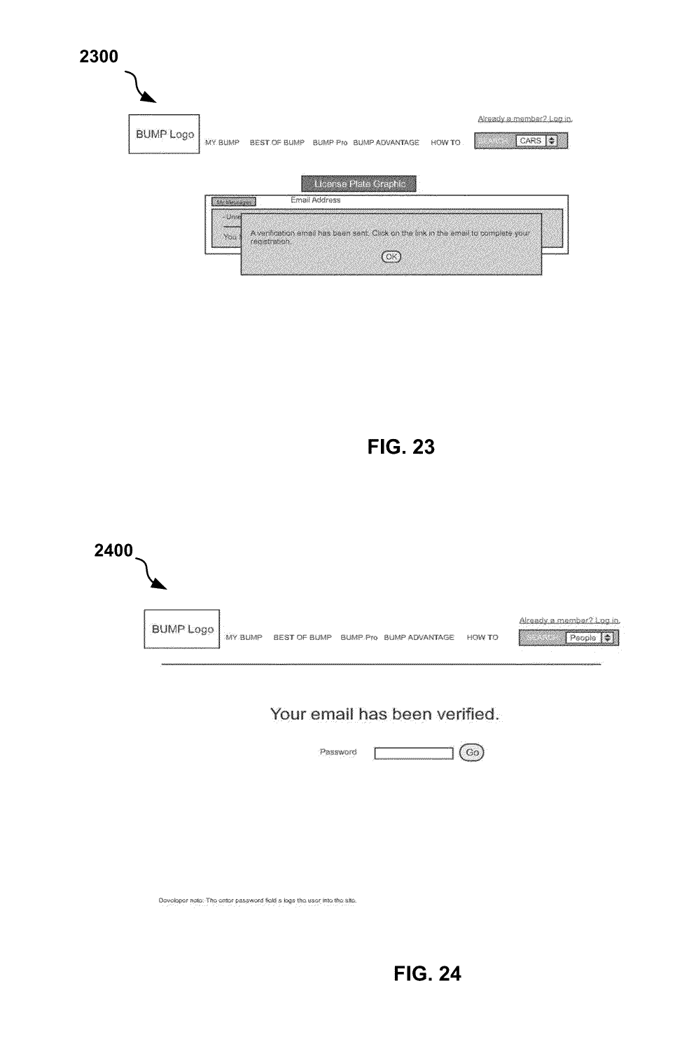

FIG. 23 illustrates details of an embodiment of a user interaction screen 2300 which may be used by a user to verify information such as may be provided through an interface screen as shown in FIG. 21.

FIG. 24 illustrates details of an embodiment of a user interaction screen 2400 which may be used by a user to indicate verification of information such as may be provided through an interface screen as shown in FIG. 23.

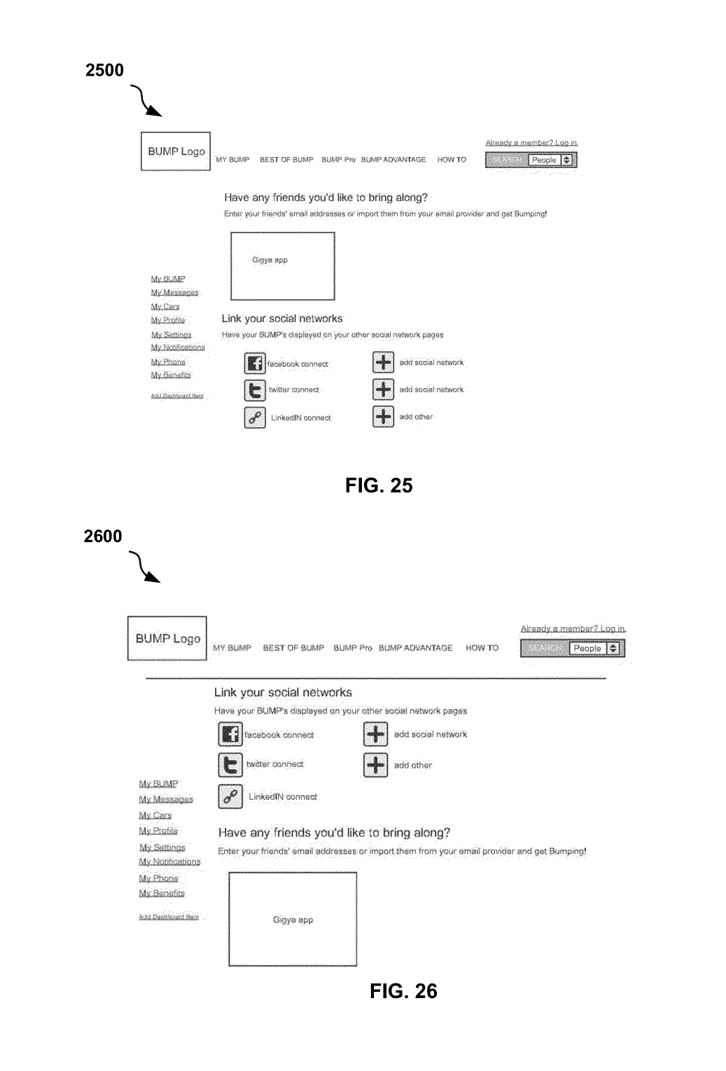

FIG. 25 illustrates details of an embodiment of a user interaction screen 2500 to facilitate linking of friends or others, as well as to social networks.

FIG. 26 illustrates details of an embodiment of a user interaction screen 2600 to facilitate linking of users to social networking or other web sites of interest.

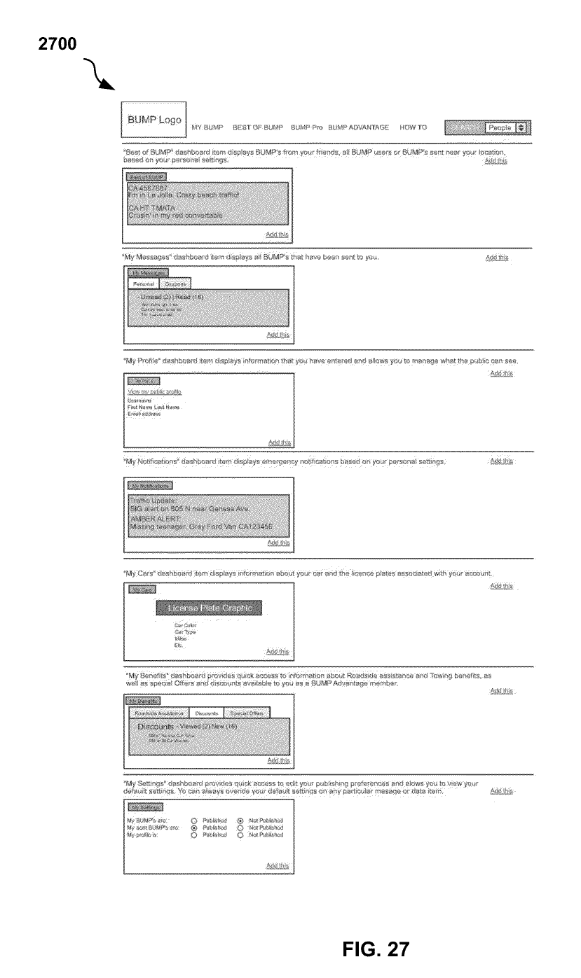

FIG. 27 illustrates details of embodiments of user screens and information 2700 such as may be provided on a mobile device using license or registration information.

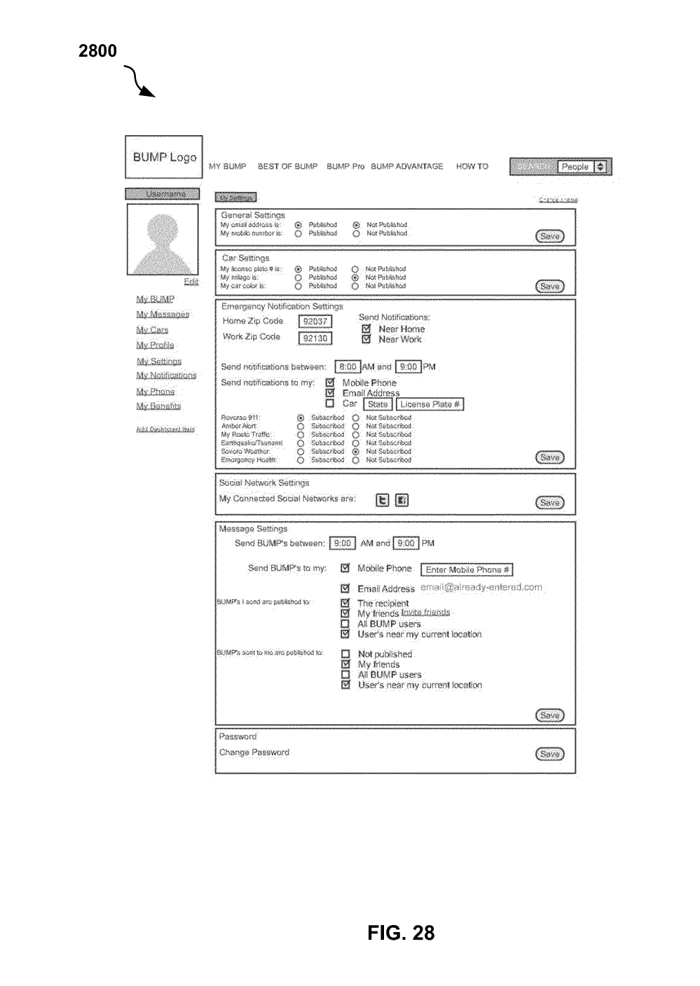

FIG. 28 illustrates details of an embodiment of a user configuration screen 2800 which may be used to facilitate user configuration of settings.

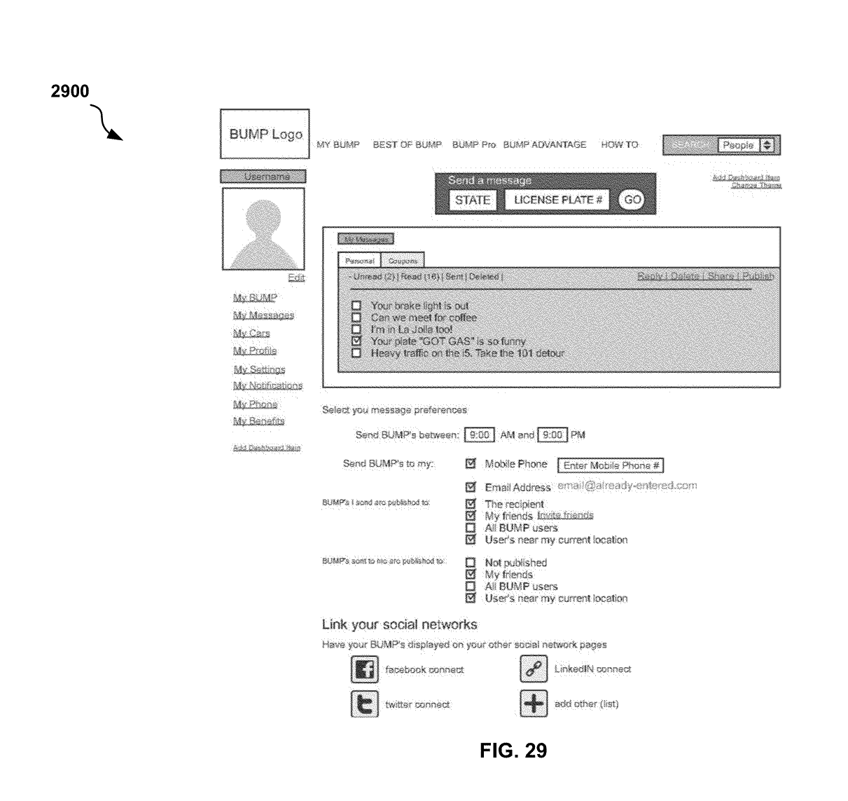

FIG. 29 illustrates details of an embodiment of a display screen 2900 with example information that may be provided to a user, such as from other users.

FIG. 30 illustrates details of an embodiment of a display screen 3000 for sending a message to another user, which may be based on license or registration information.

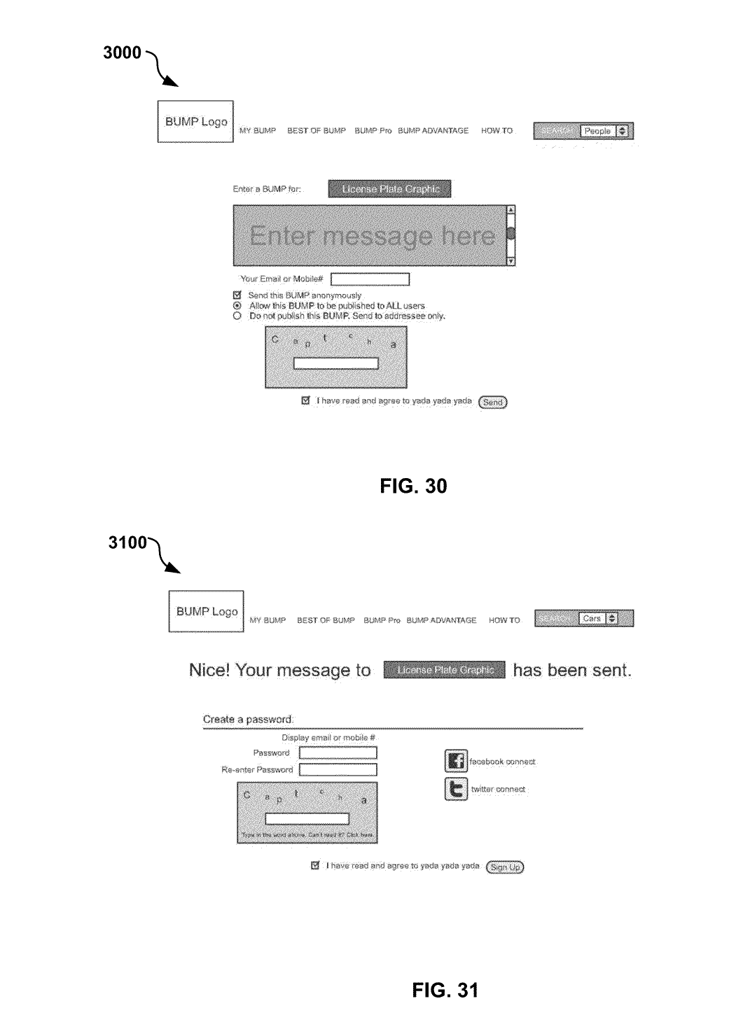

FIG. 31 illustrates details of an embodiment of a display screen 3100 for acknowledging transmission of a message to another user.

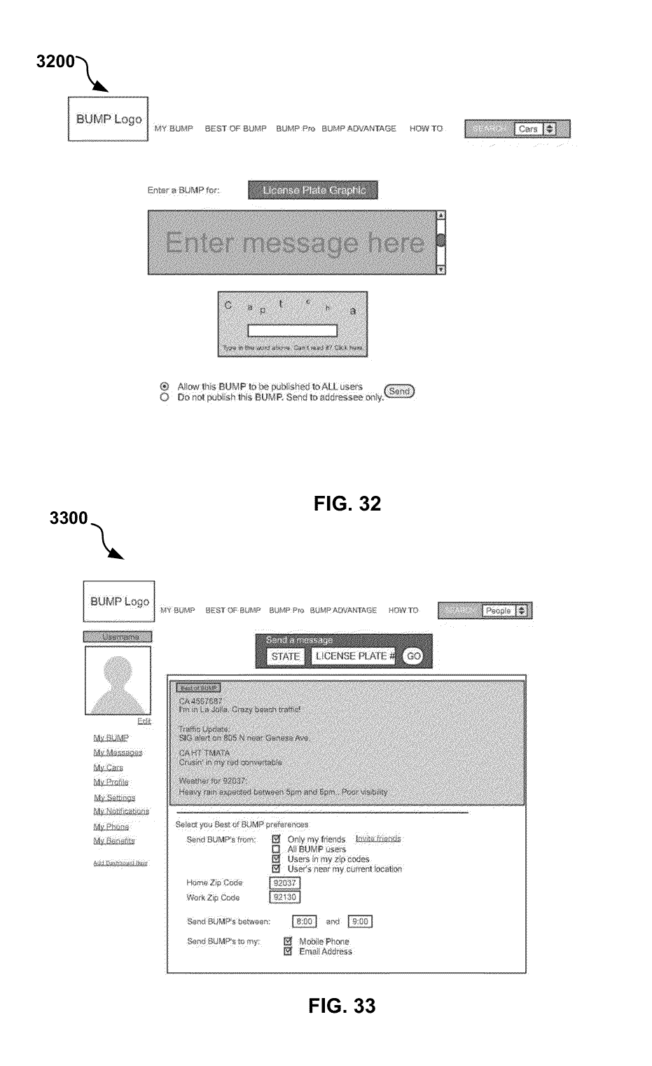

FIG. 32 illustrates details of an embodiment of a display screen 3200 for sending a BUMP to a set of all users configured to receive messages or information.

FIG. 33 illustrates details of an embodiment of a display screen 3300 for setting user preferences.

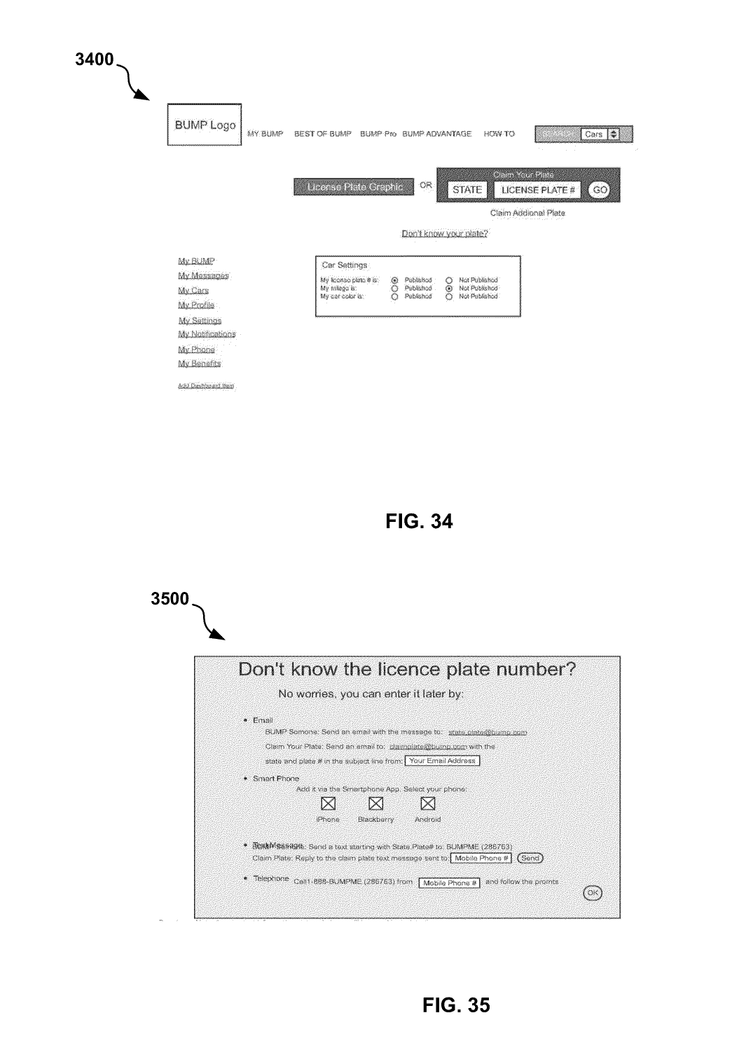

FIG. 34 illustrates details of an embodiment of a display screen 3400 for configuring car settings.

FIG. 35 illustrates details of an embodiment of a display screen 3500 for setting configuration without knowledge of a license or registration number.

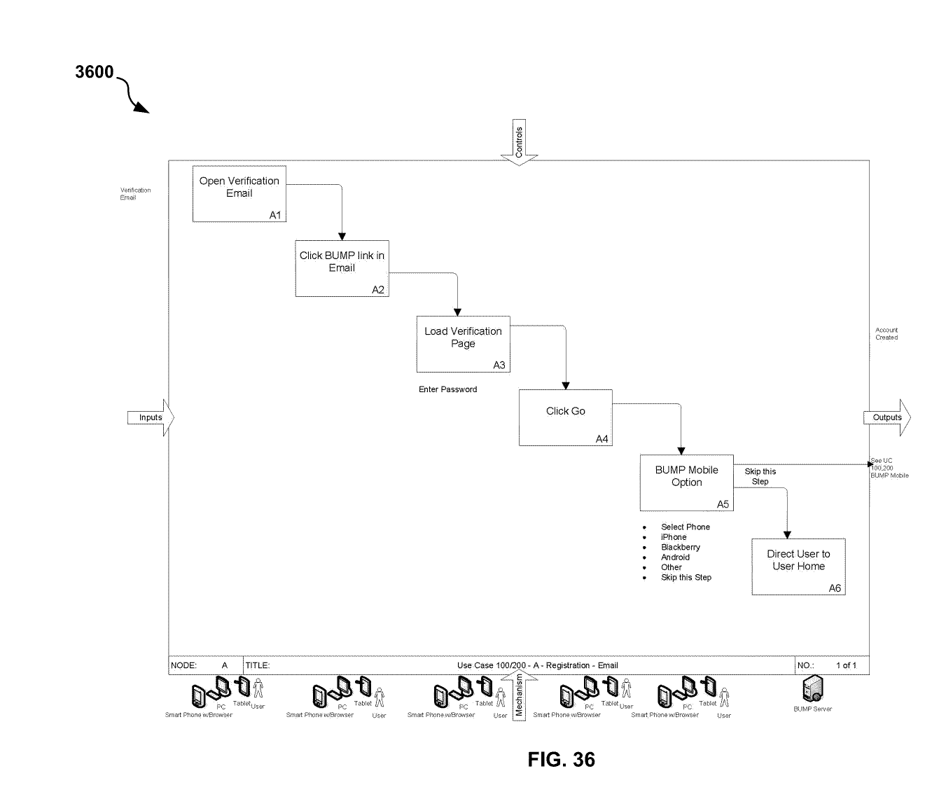

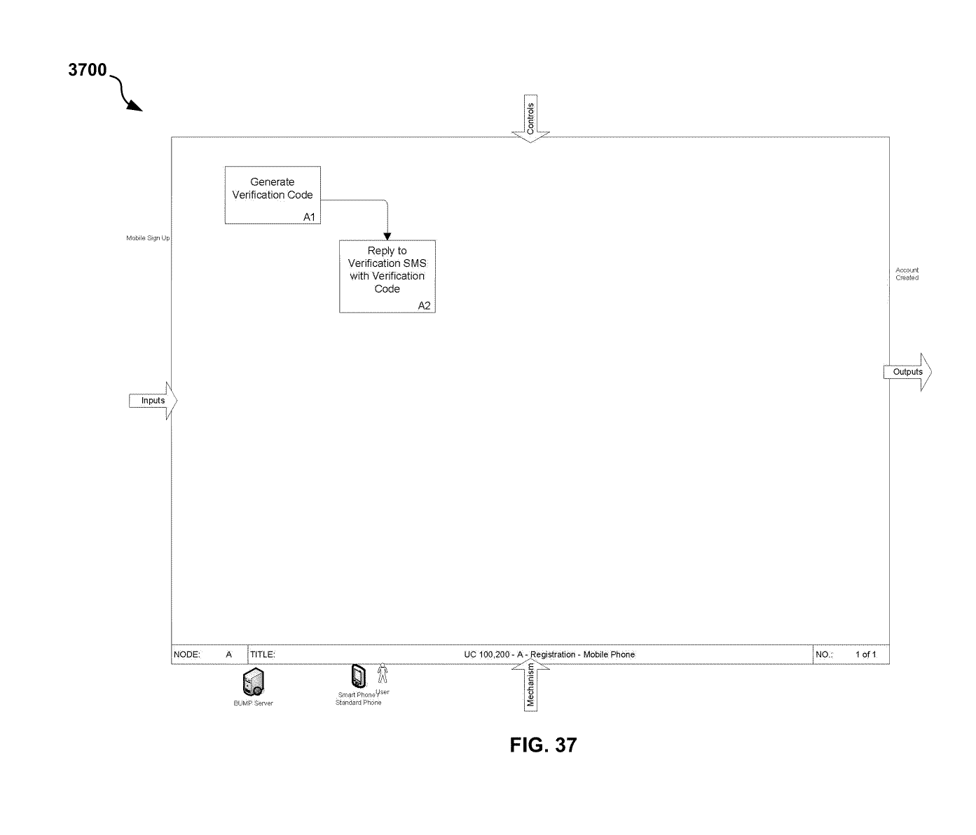

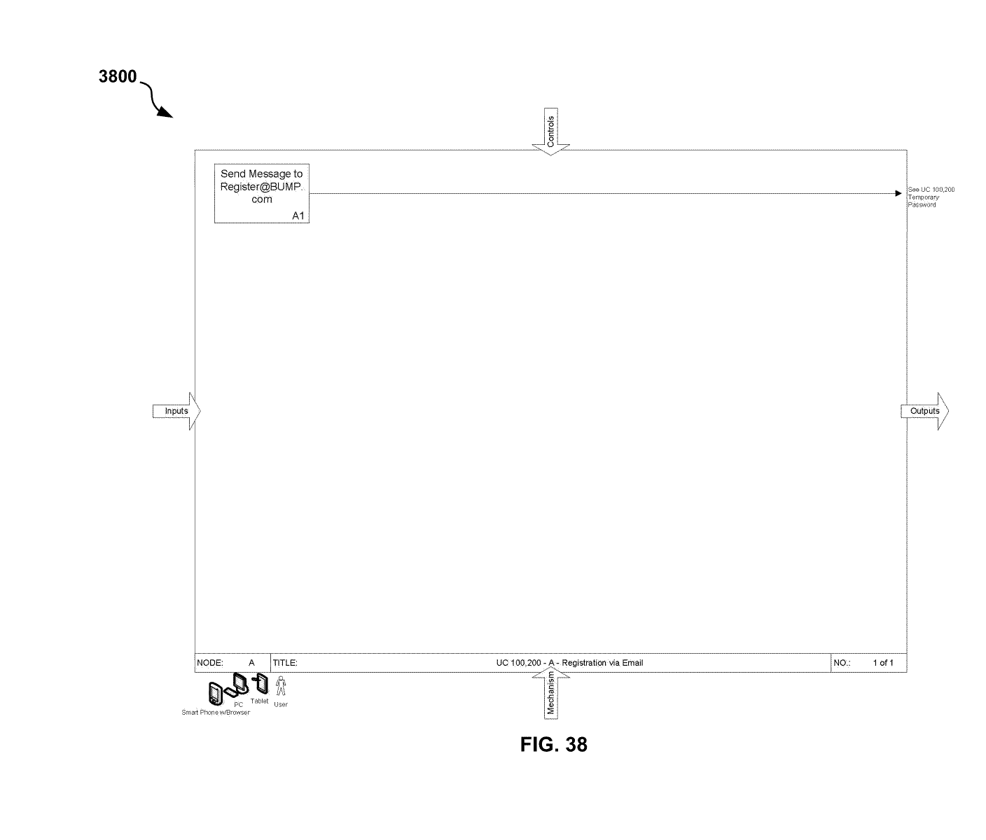

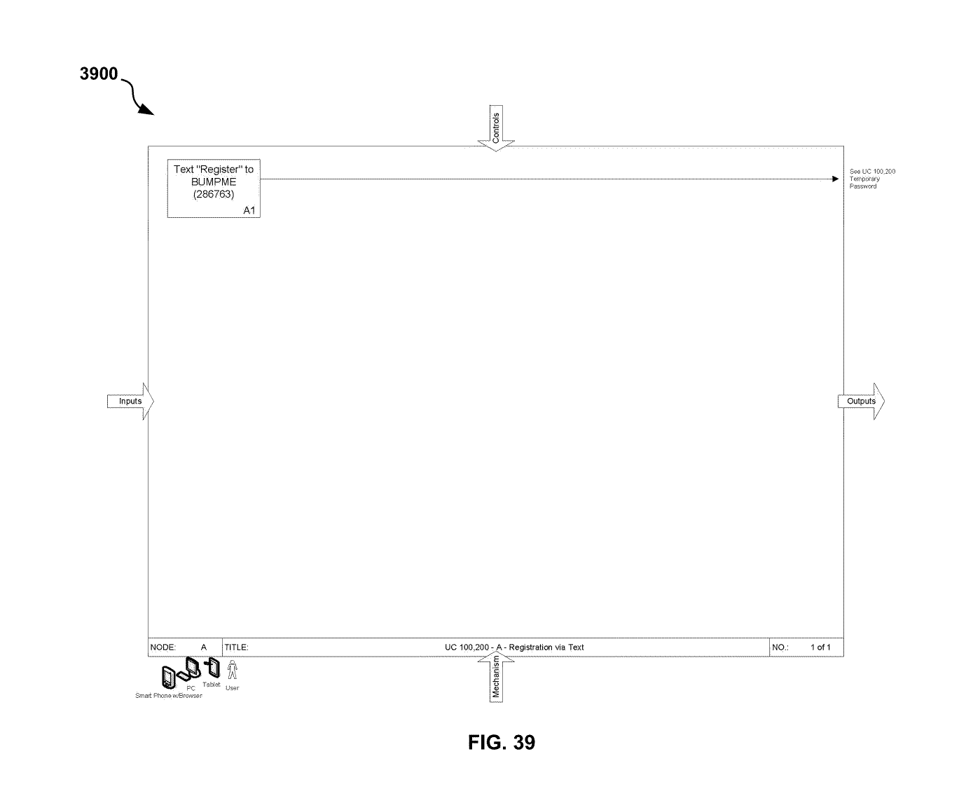

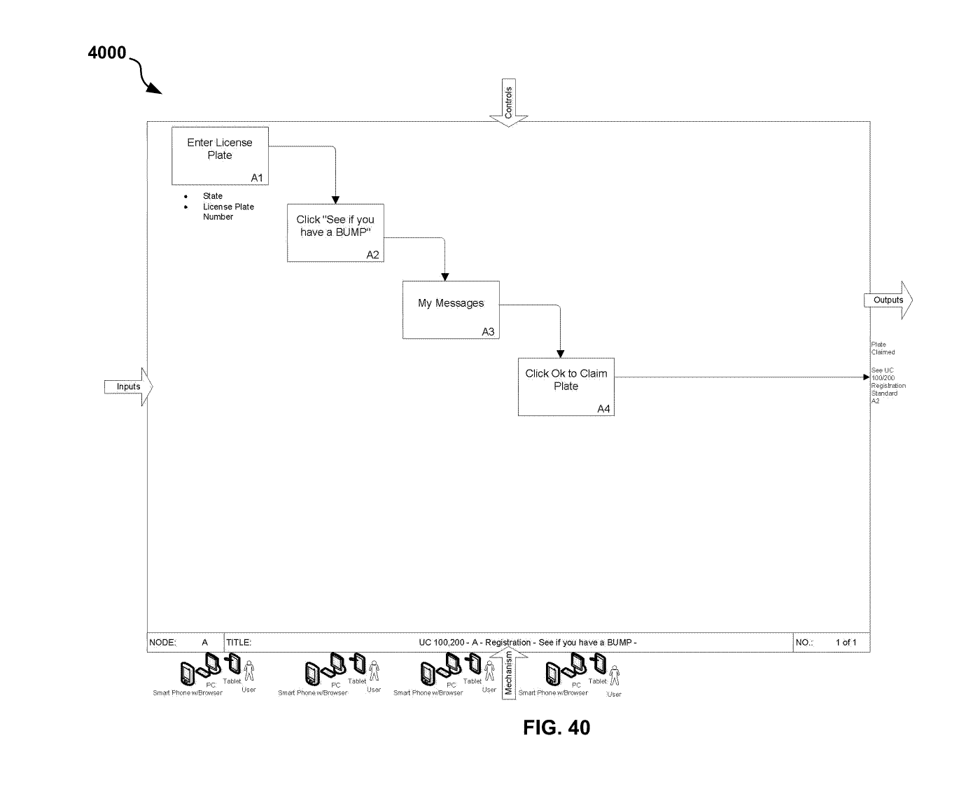

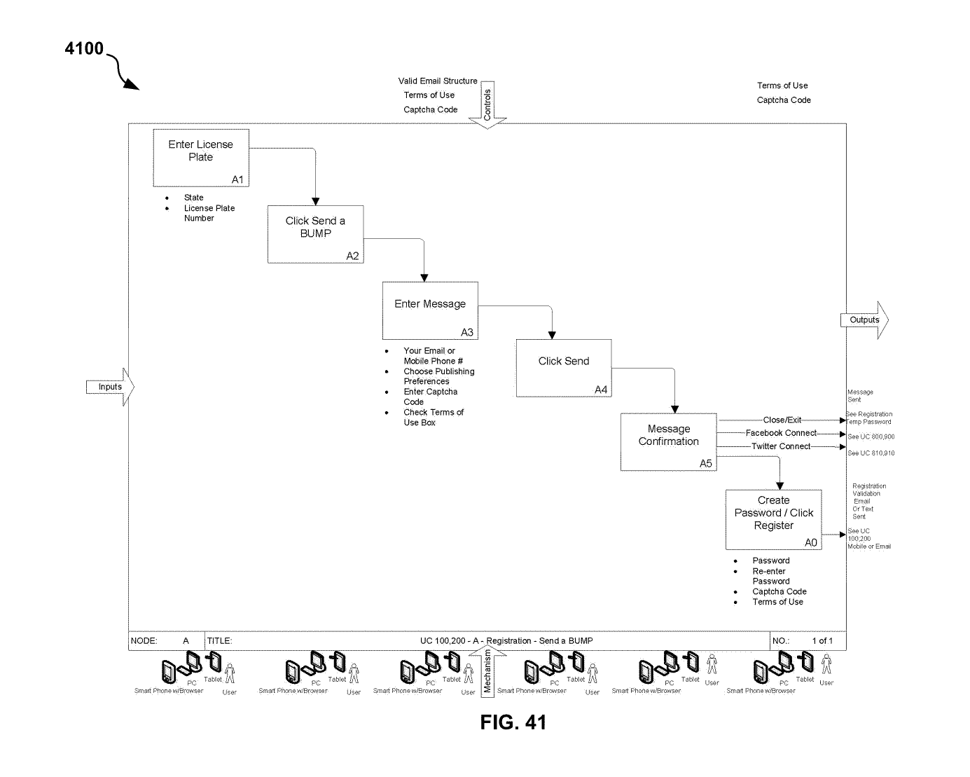

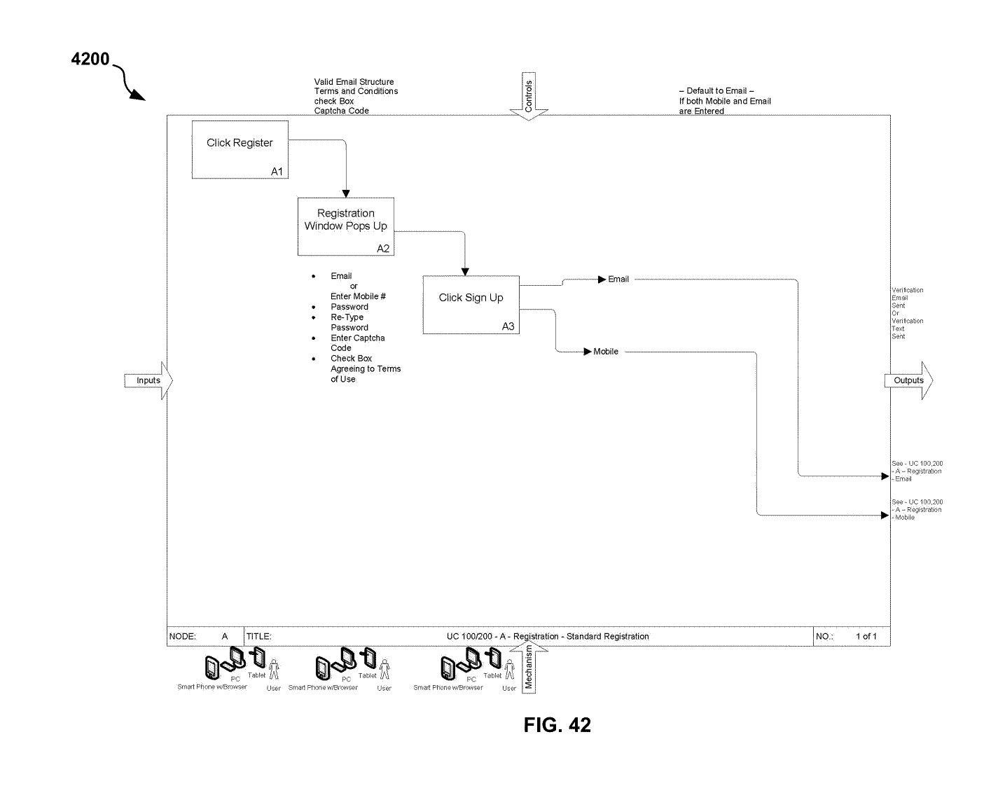

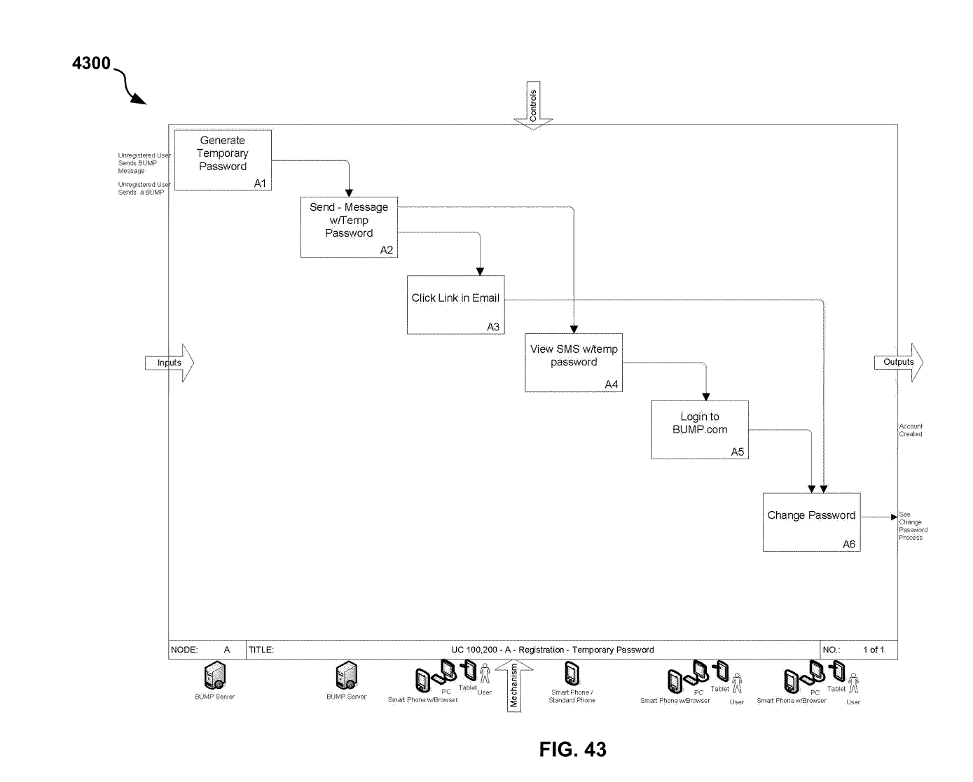

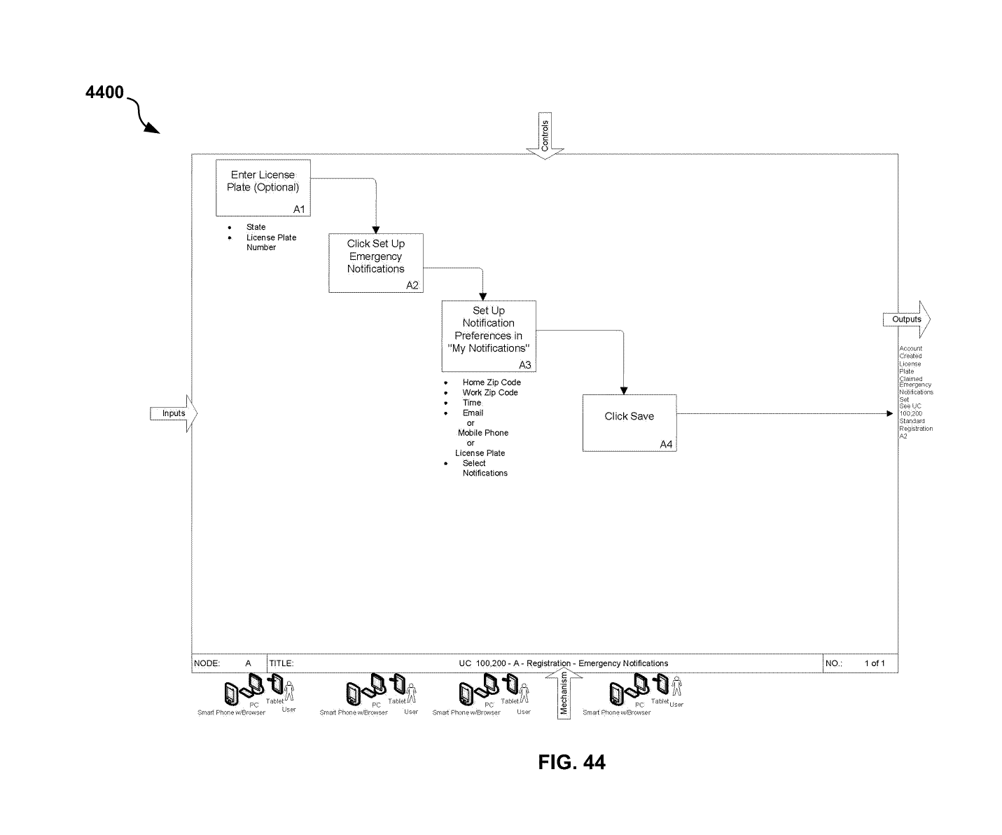

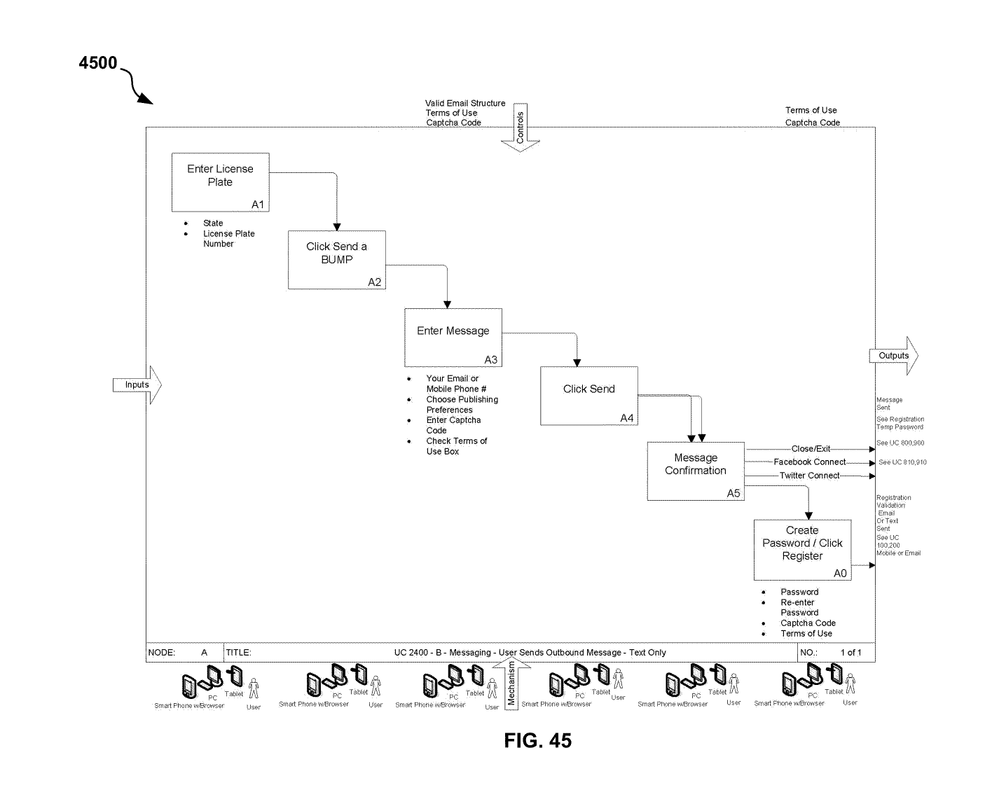

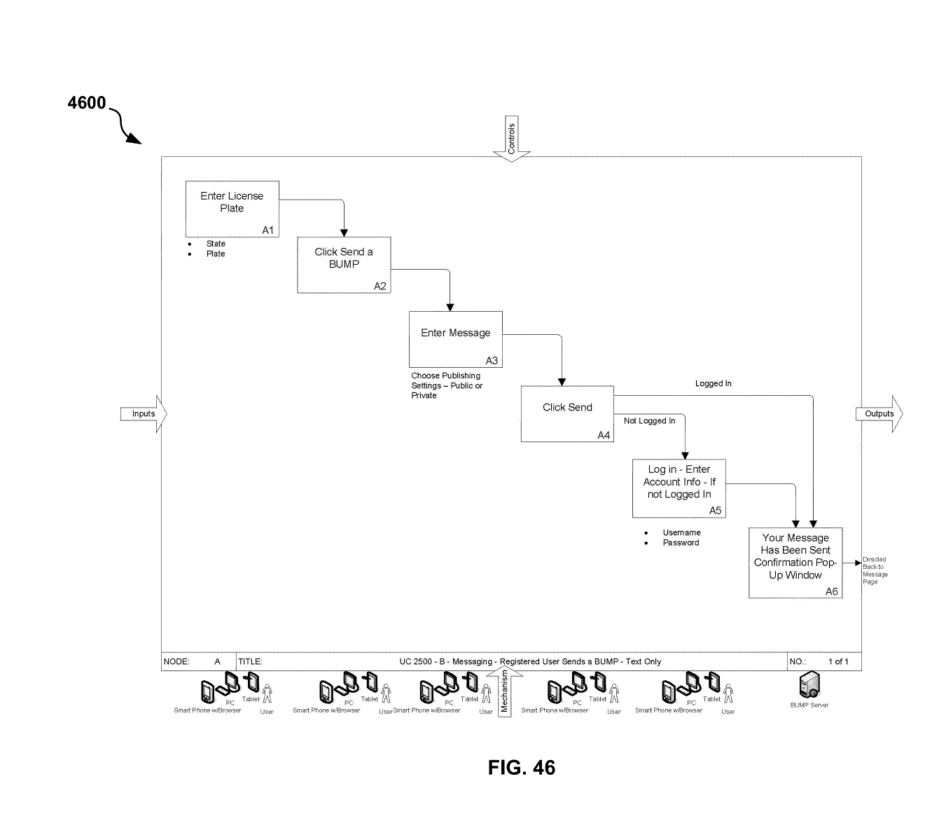

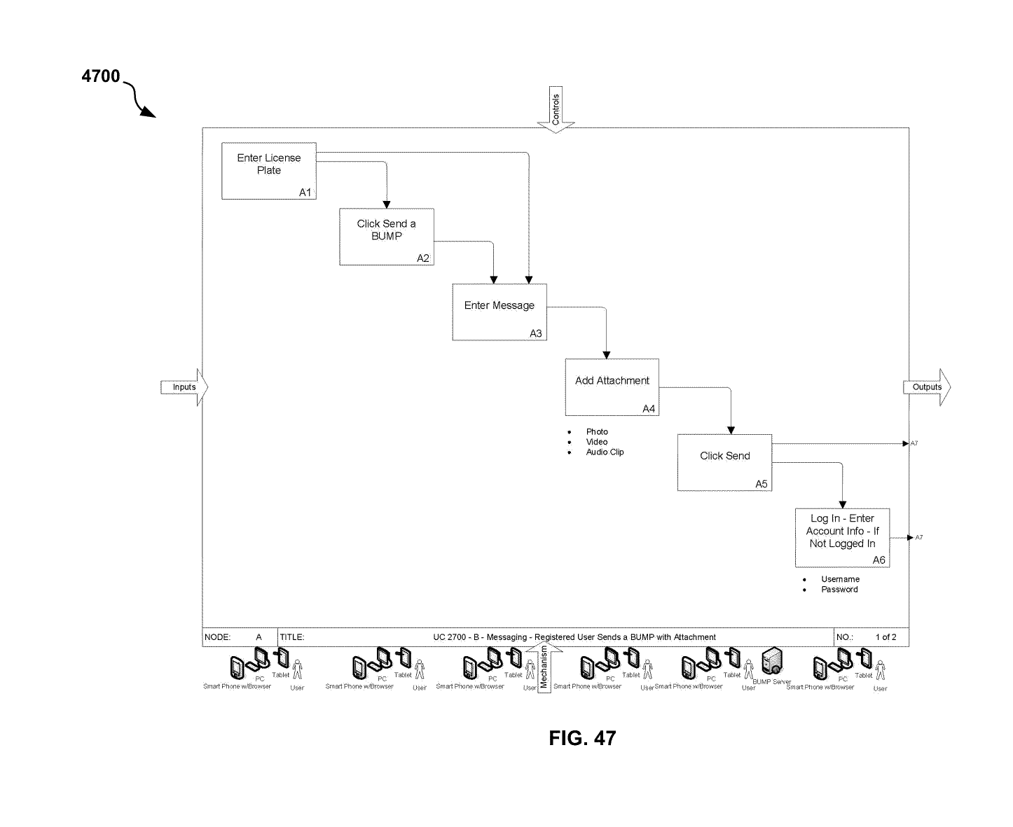

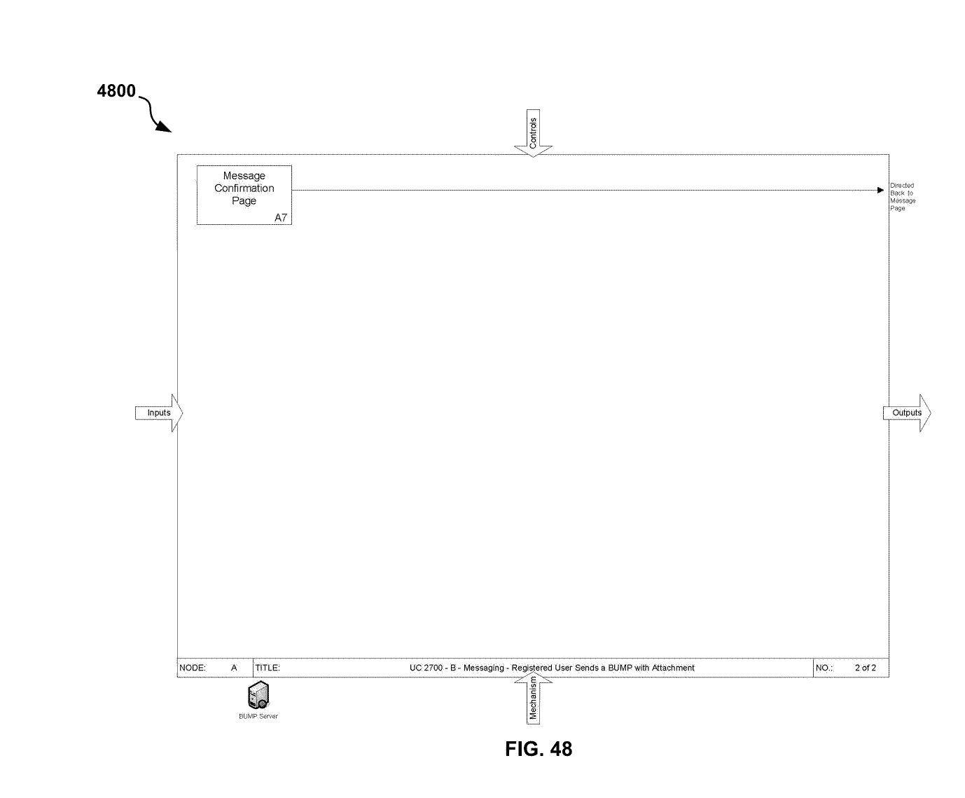

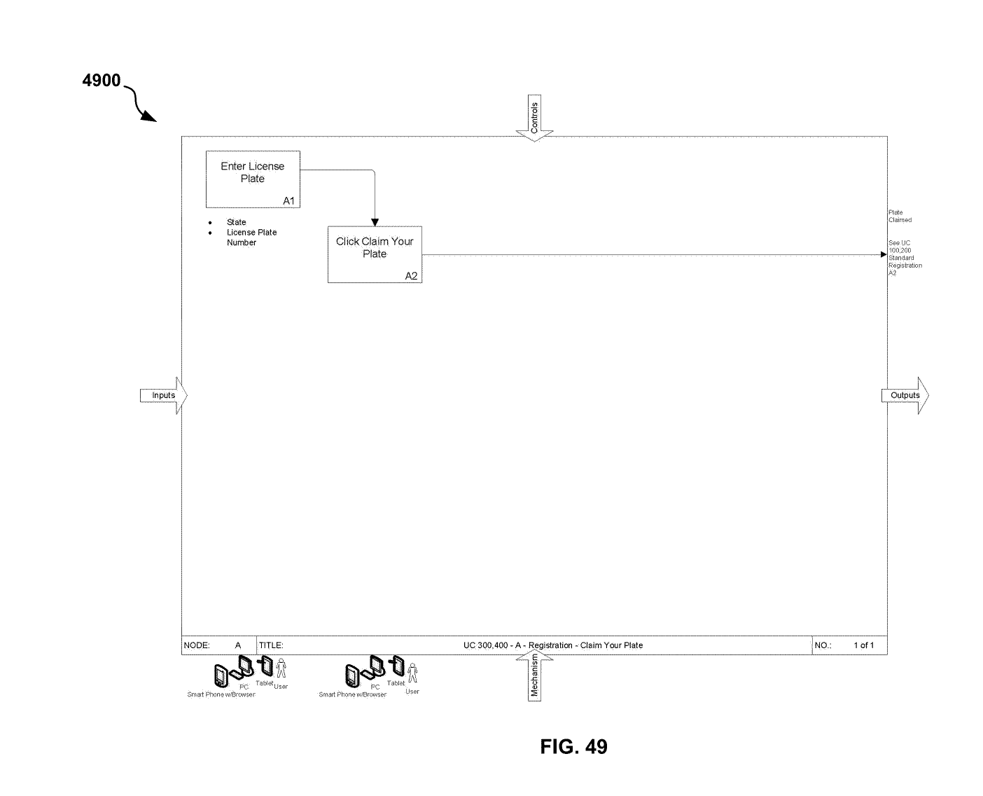

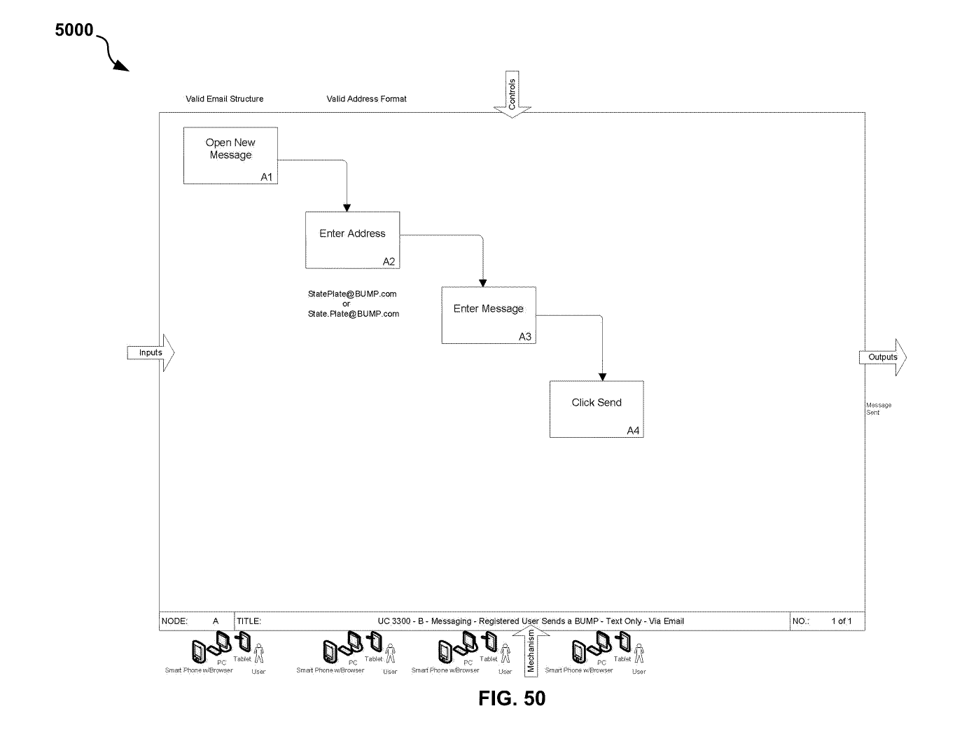

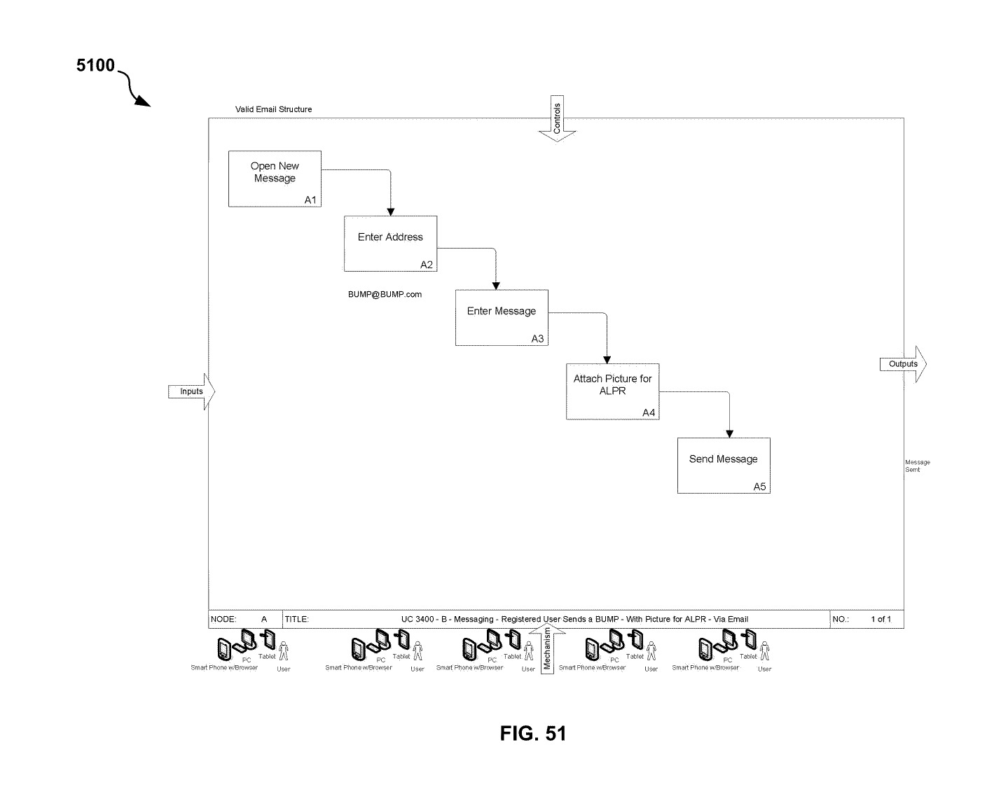

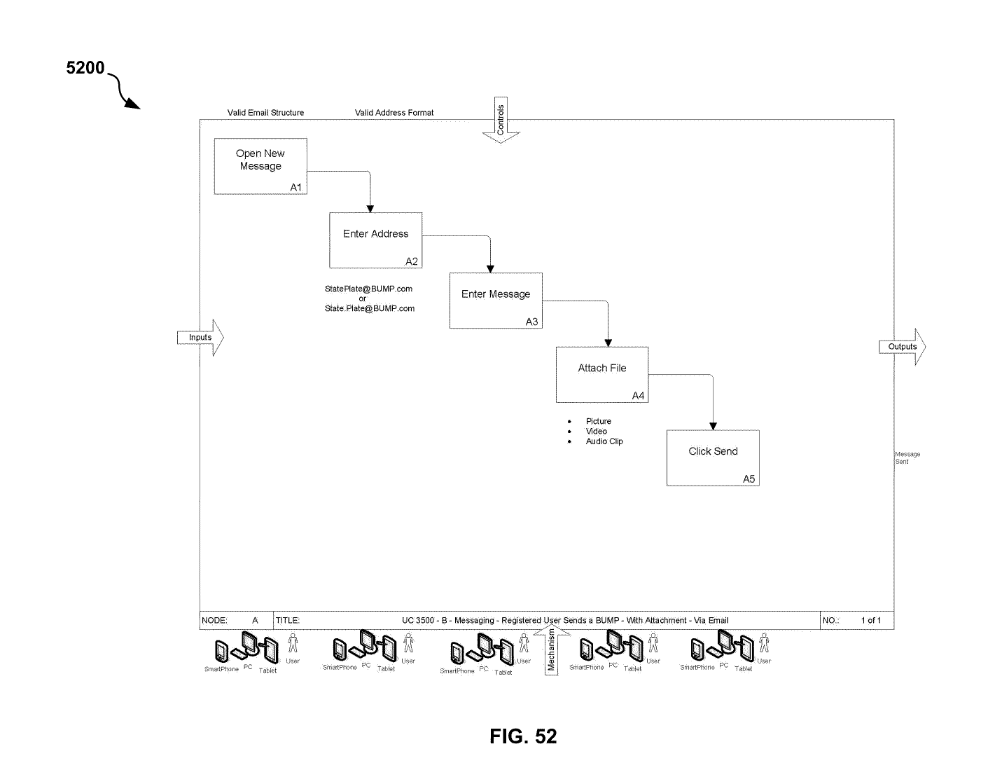

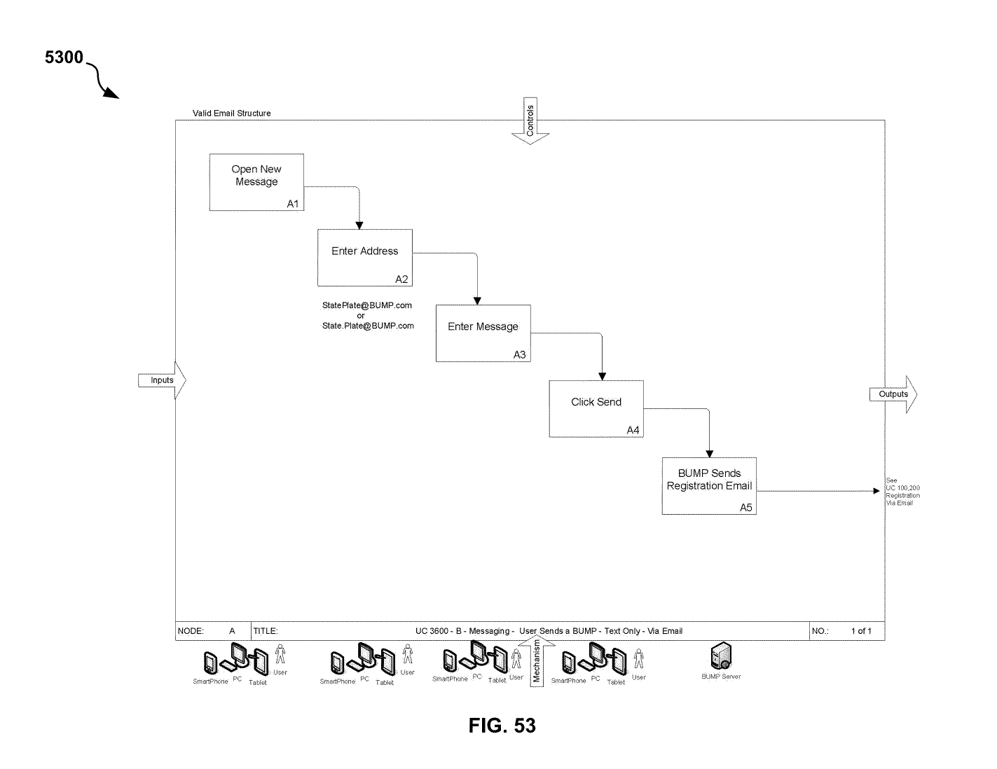

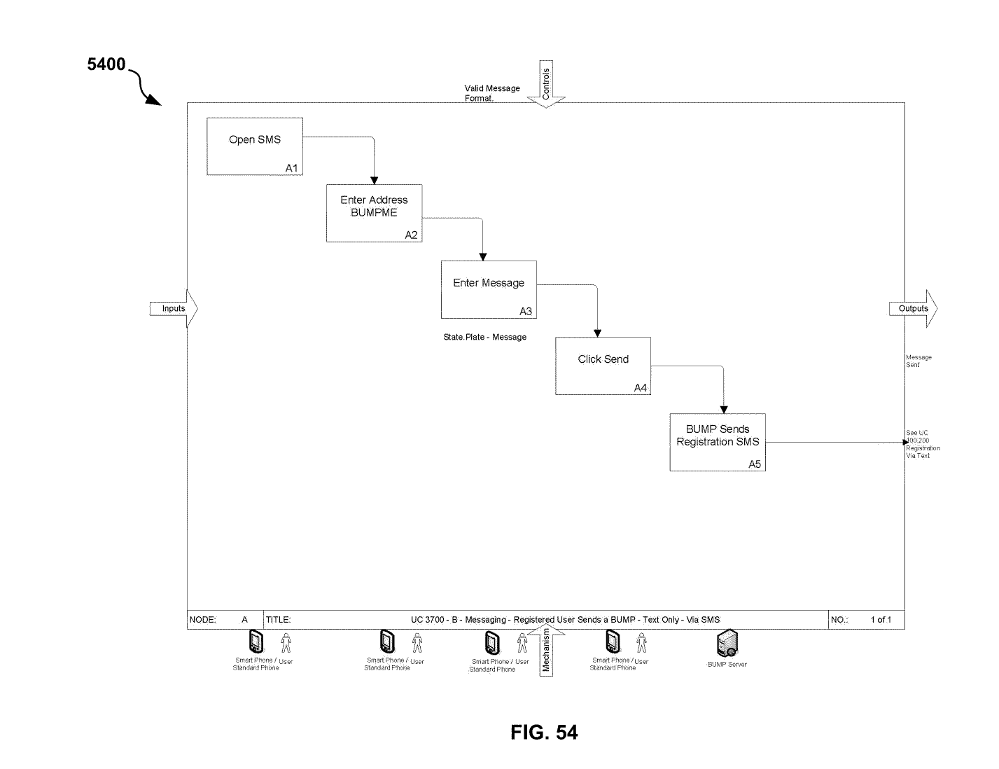

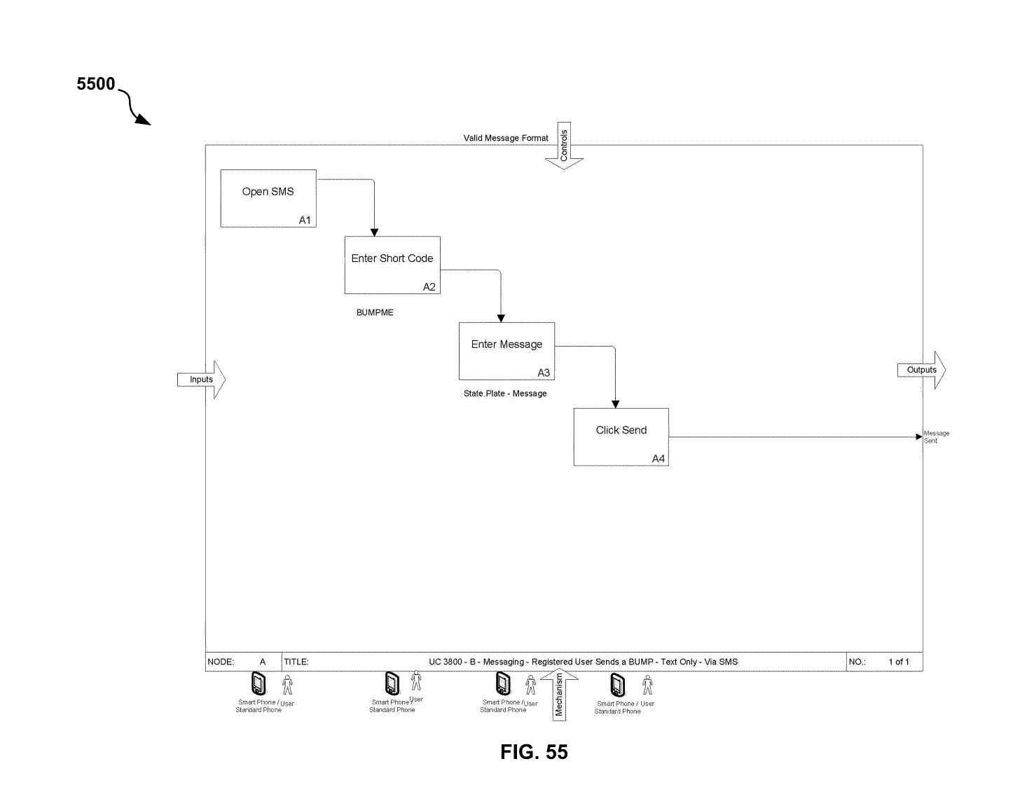

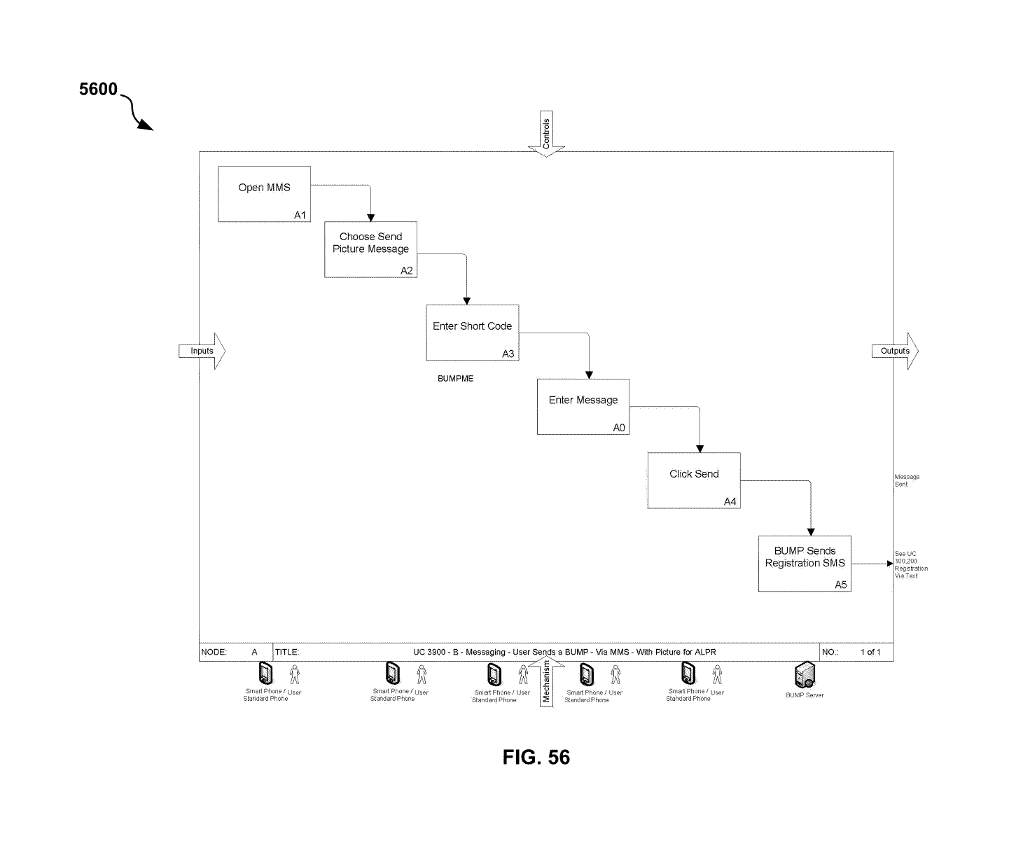

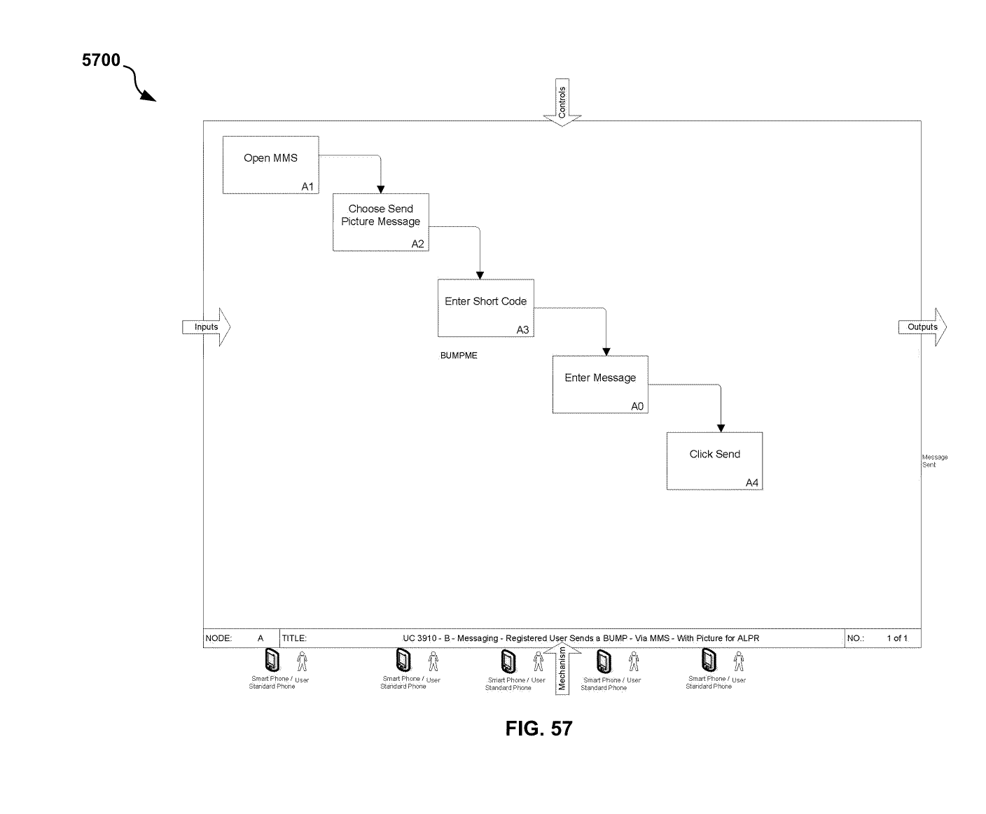

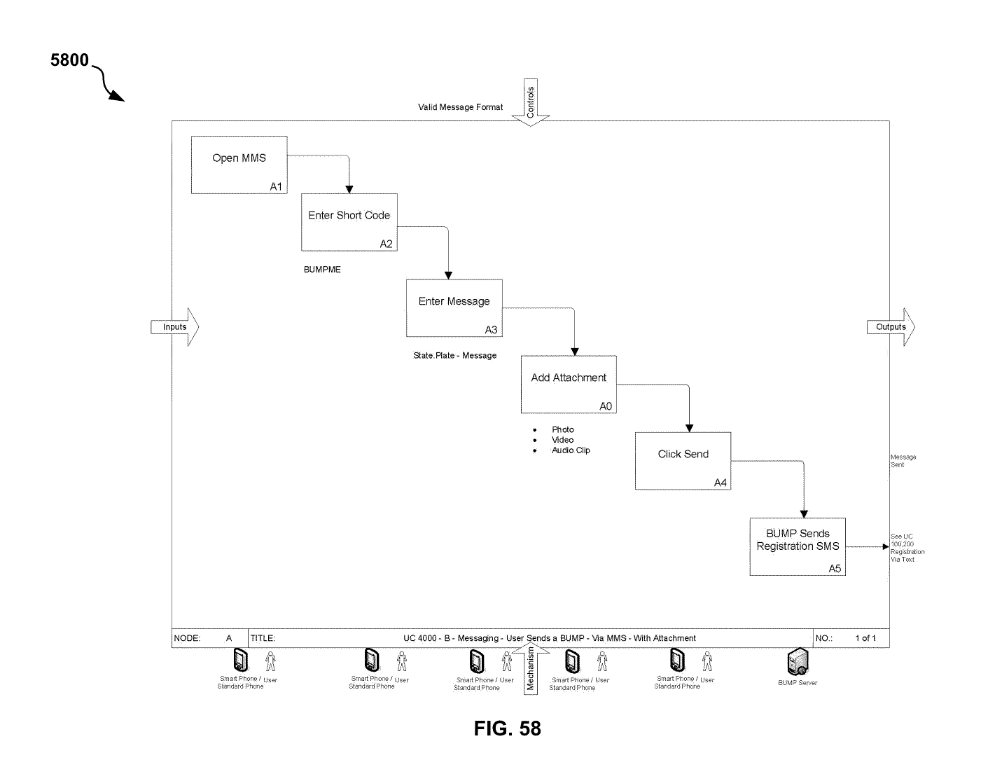

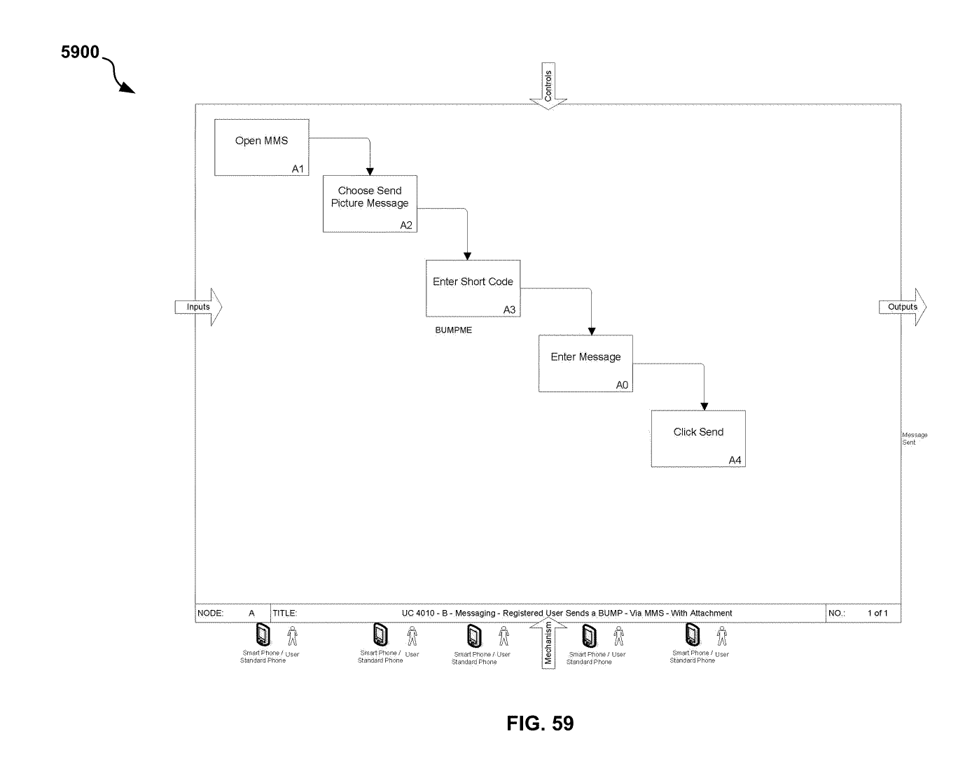

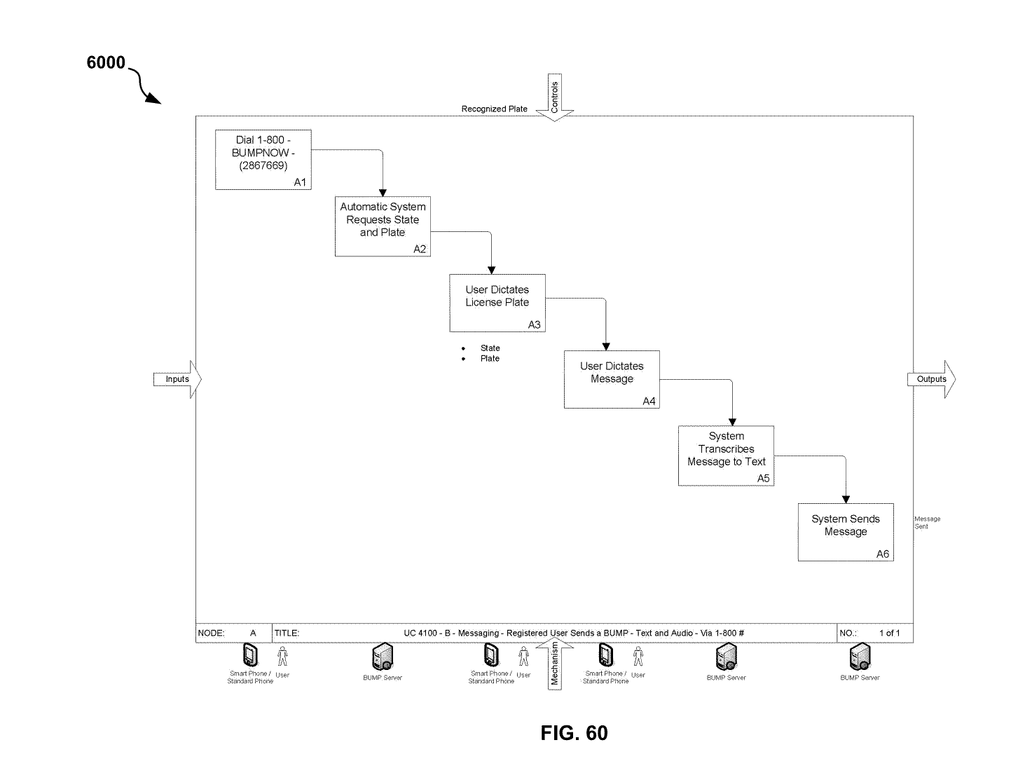

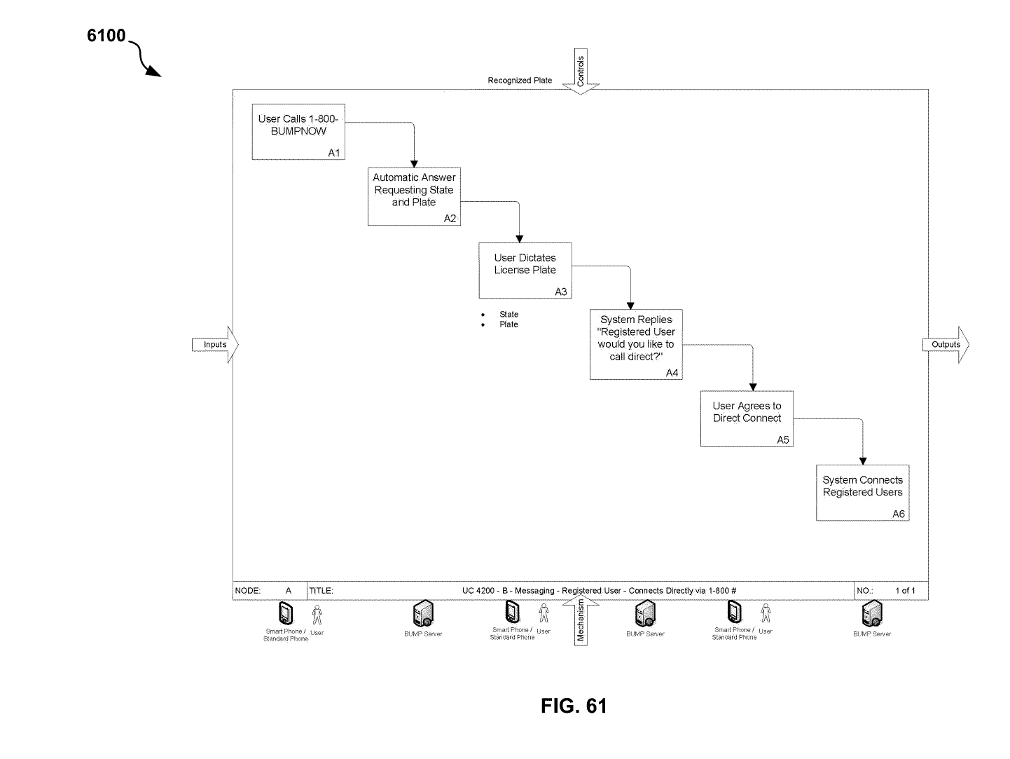

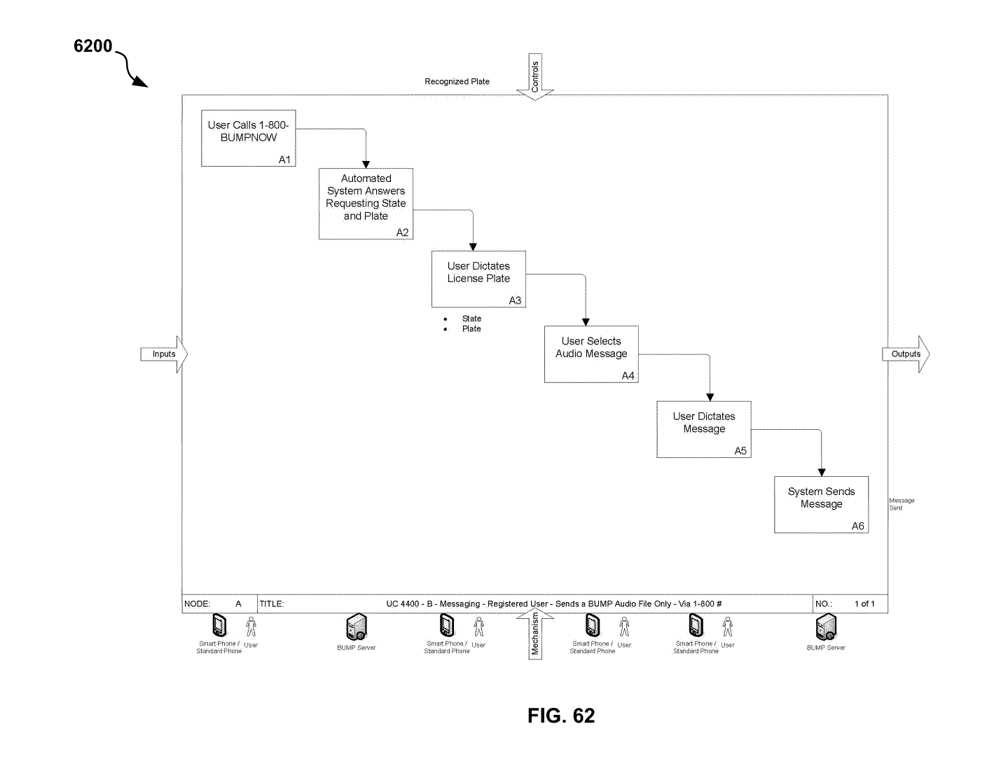

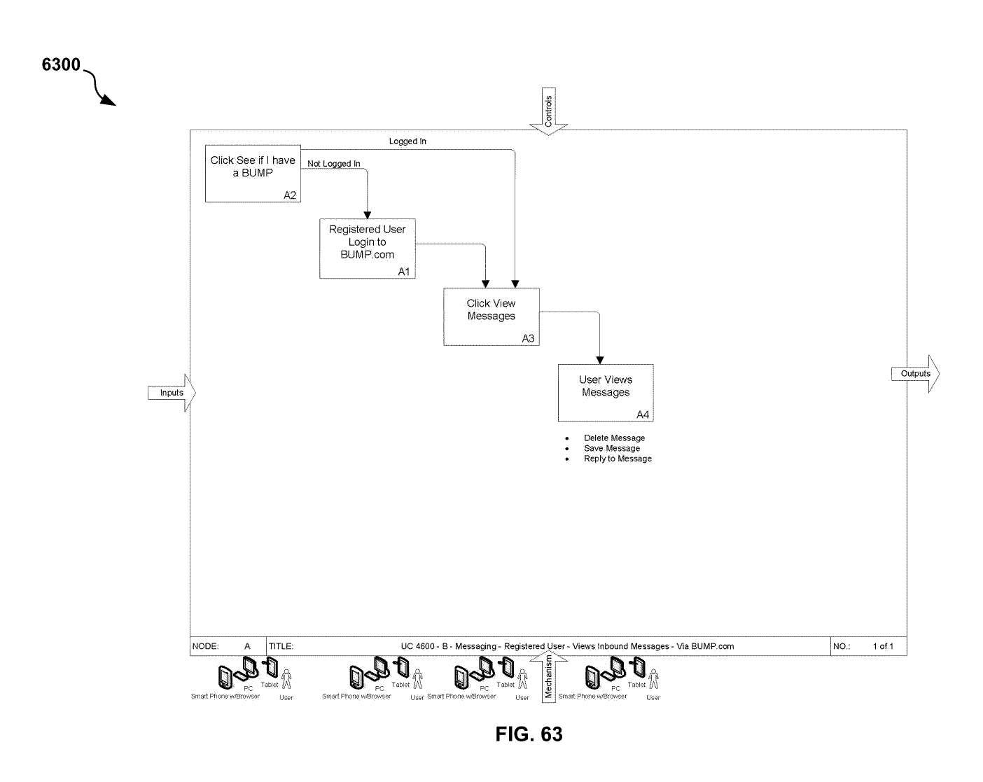

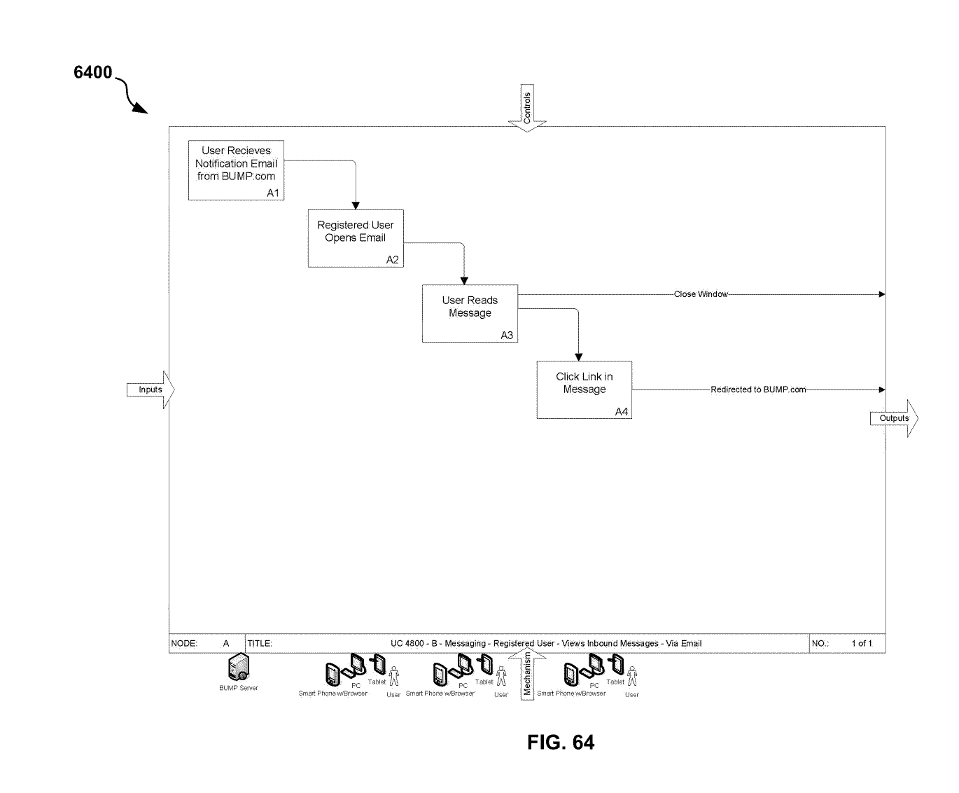

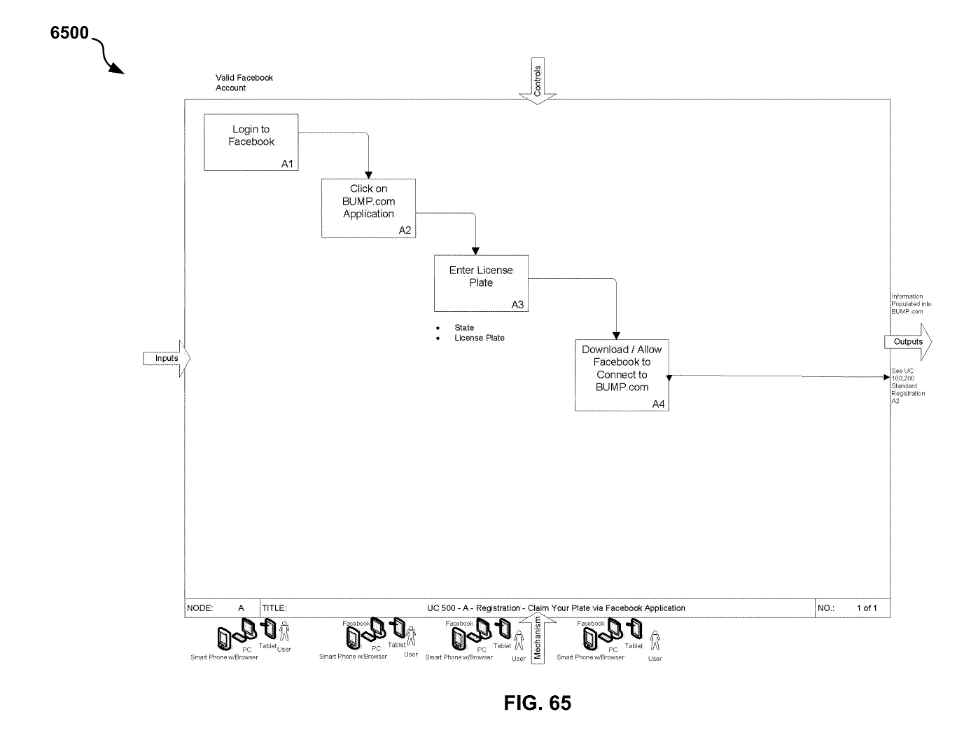

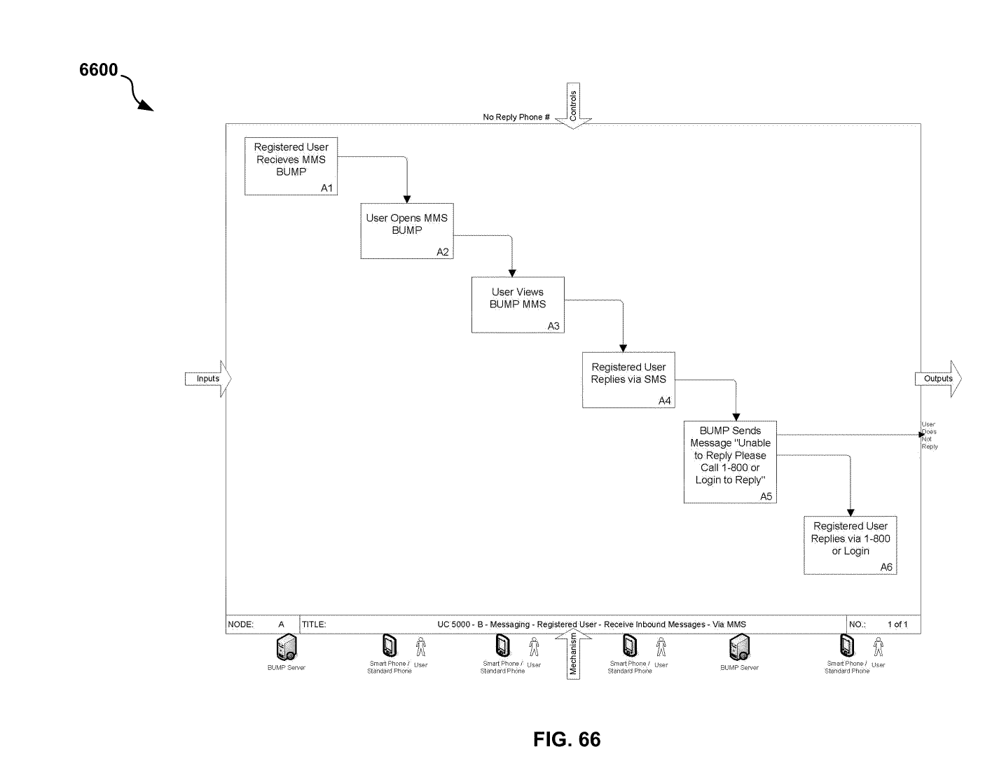

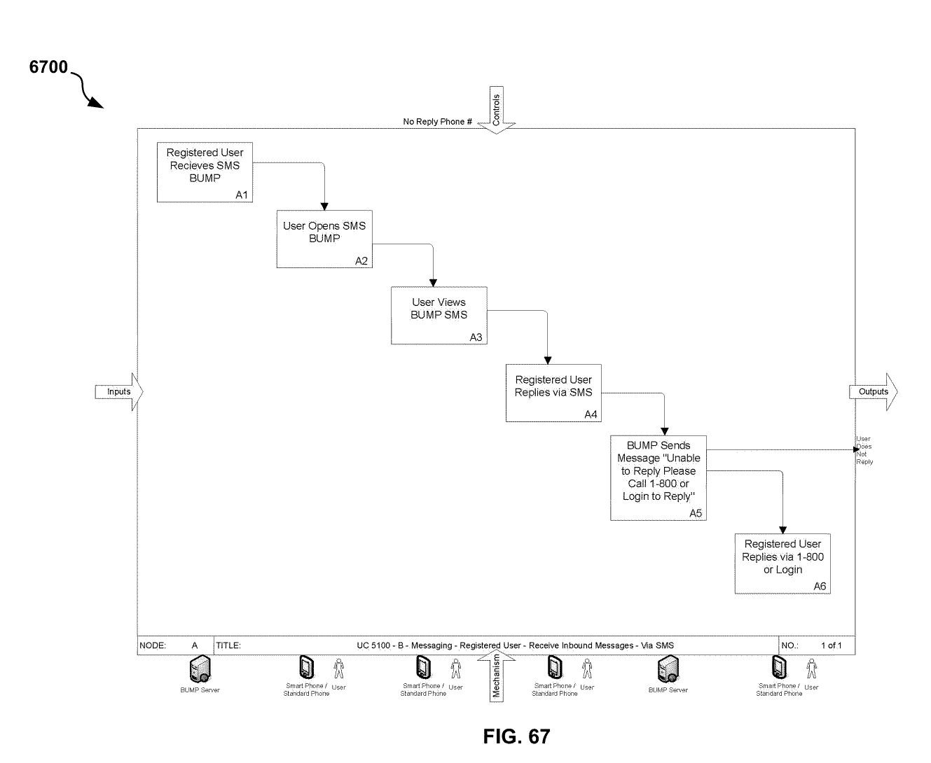

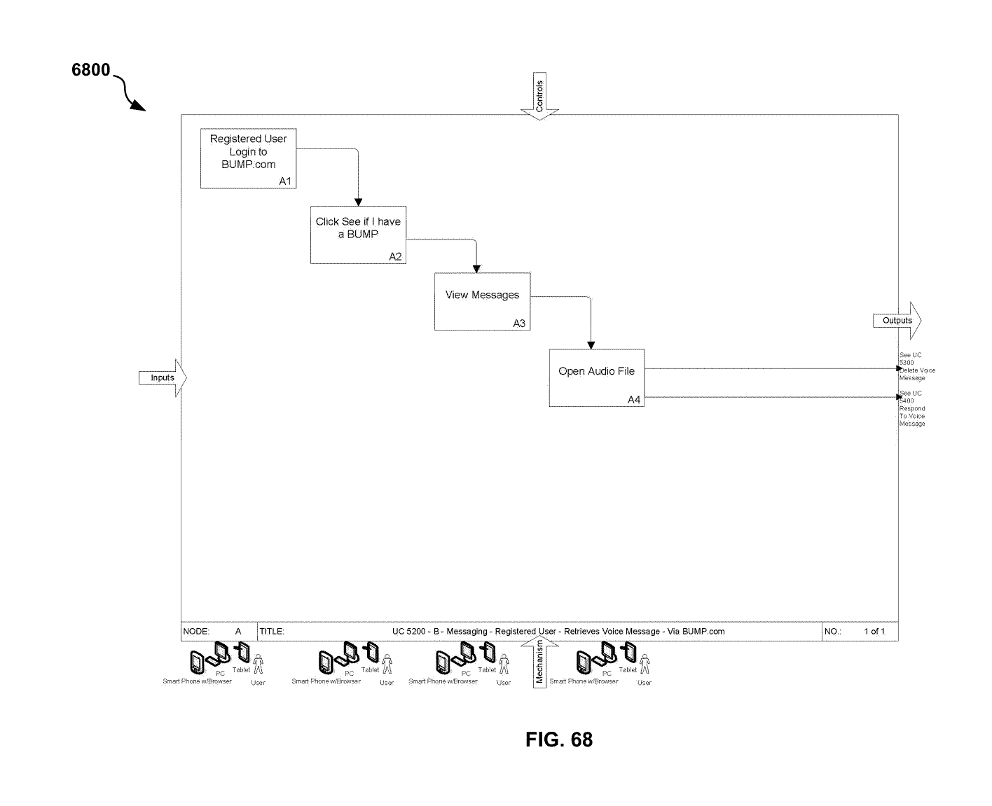

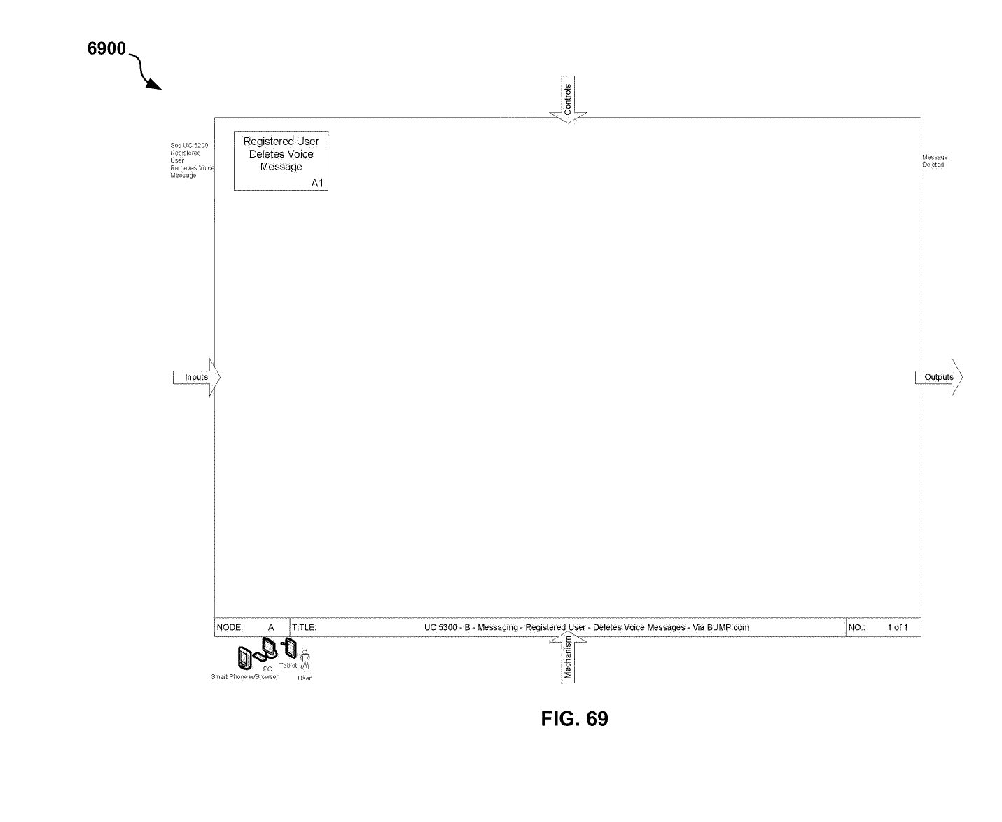

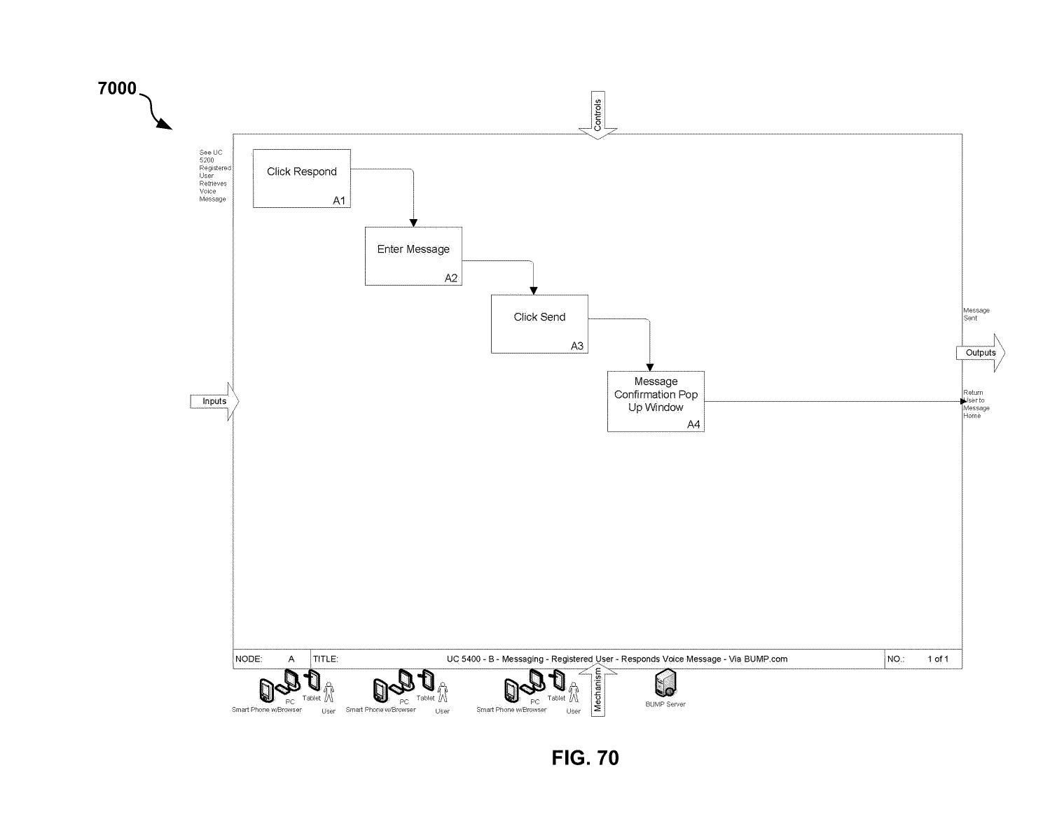

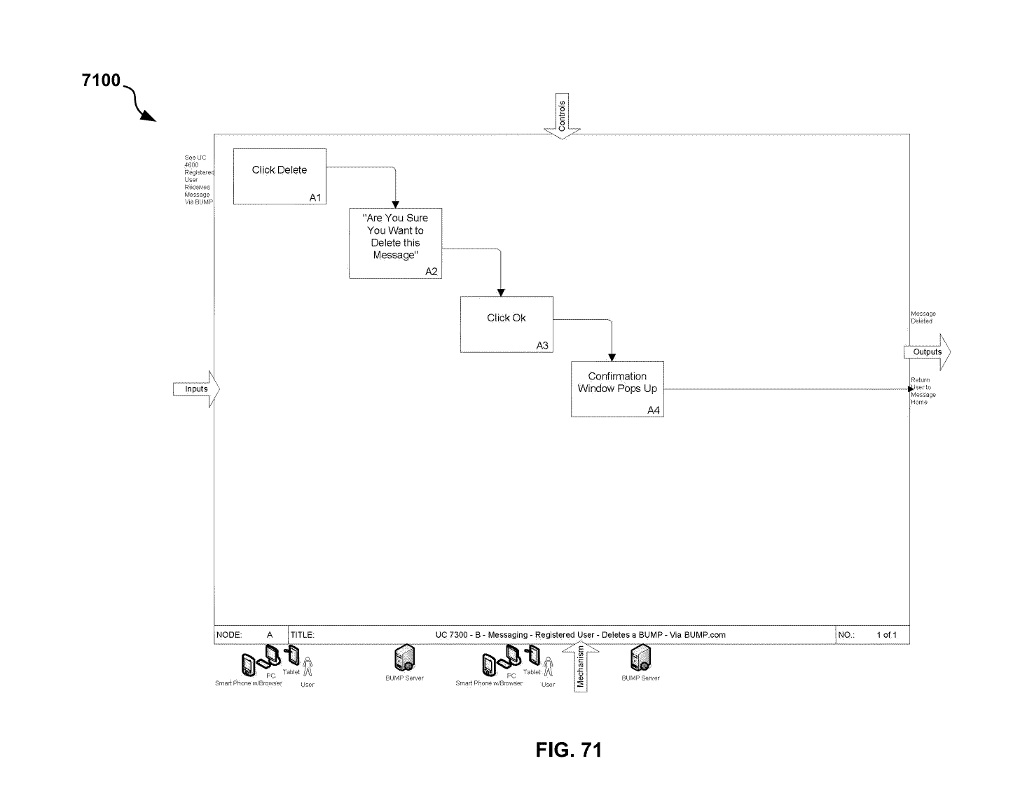

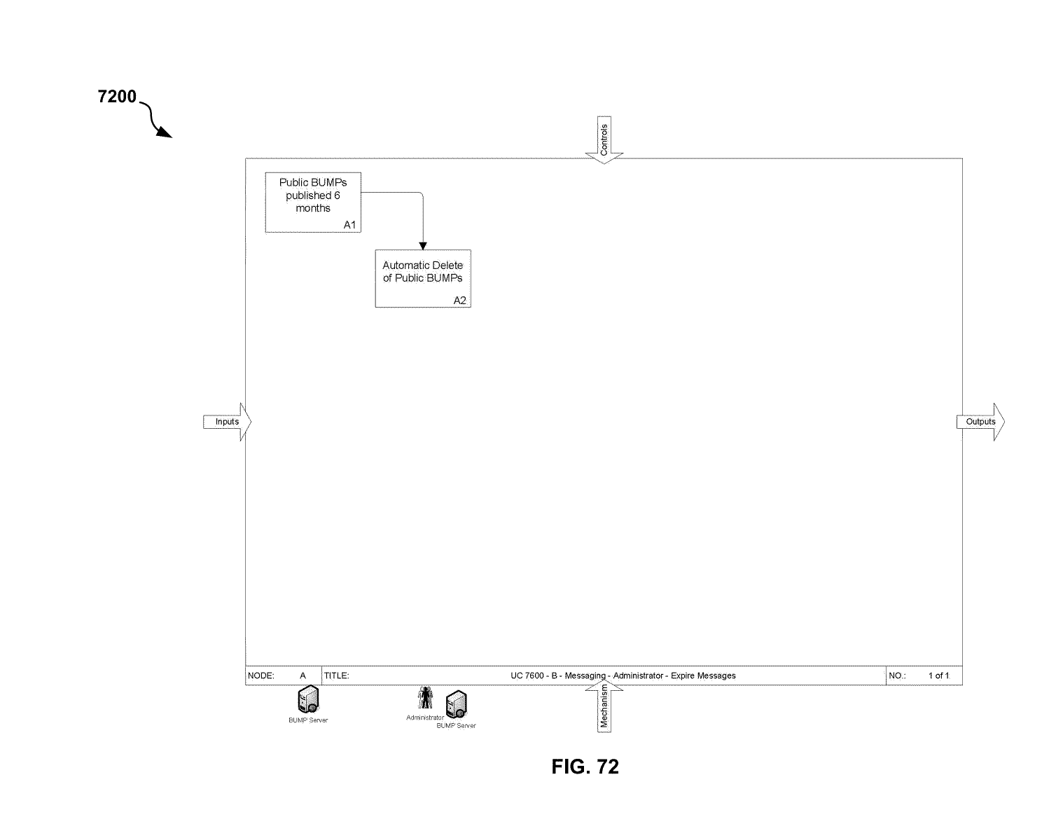

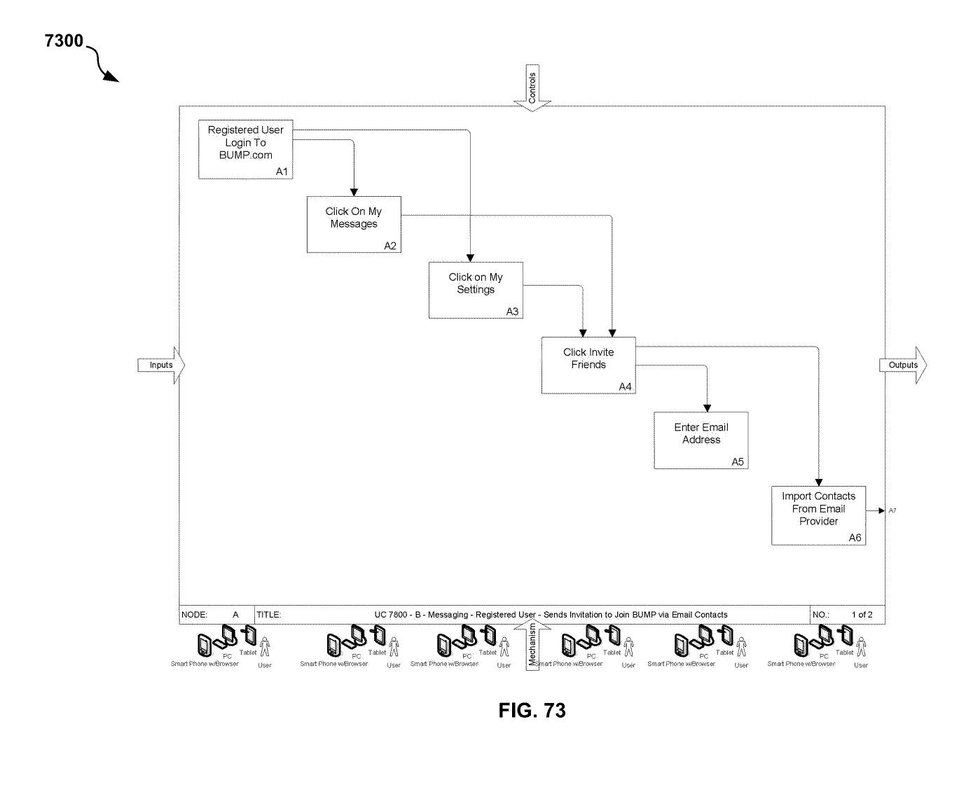

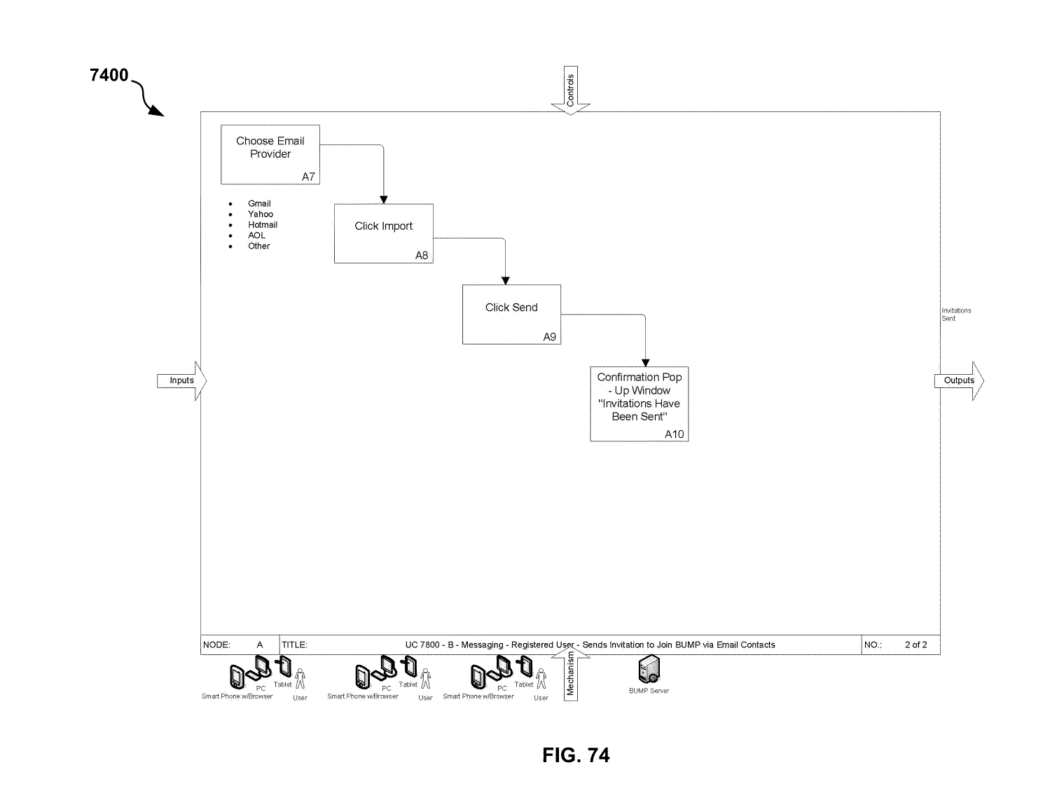

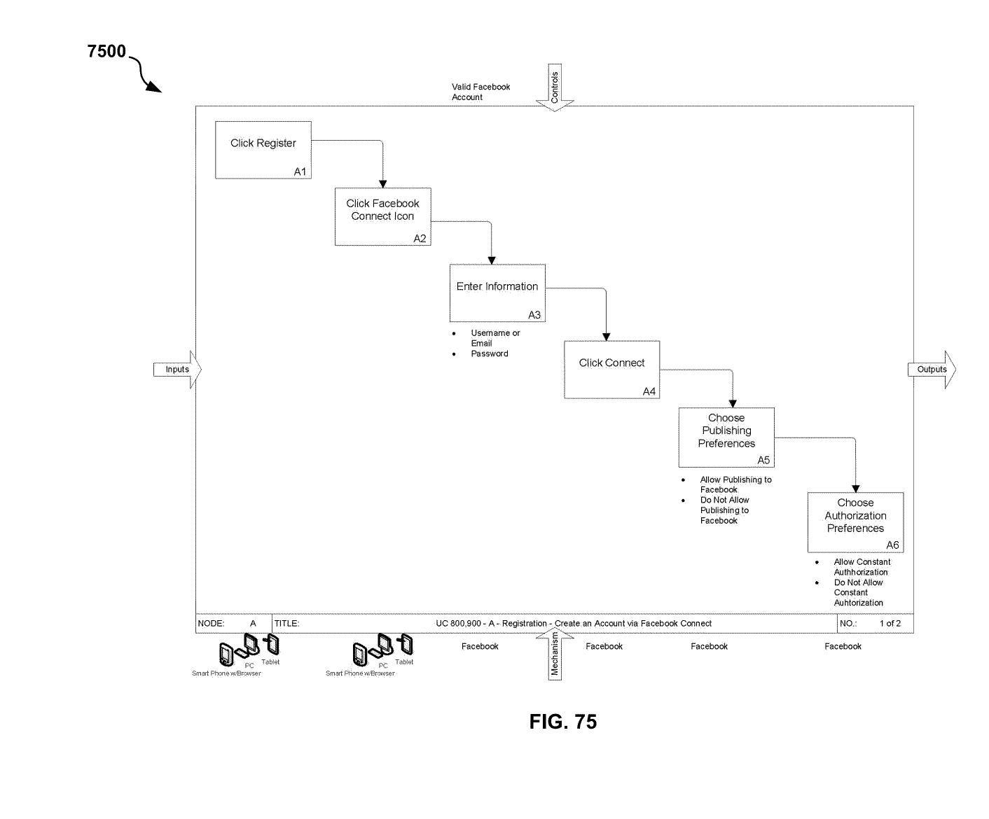

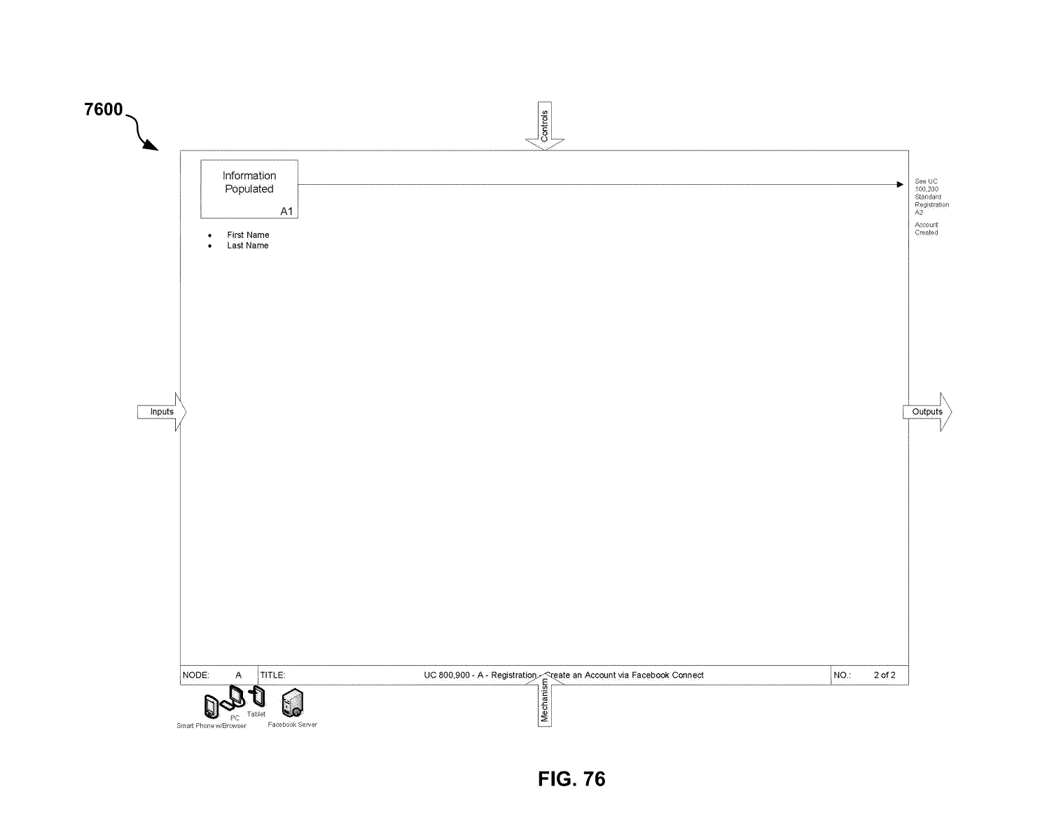

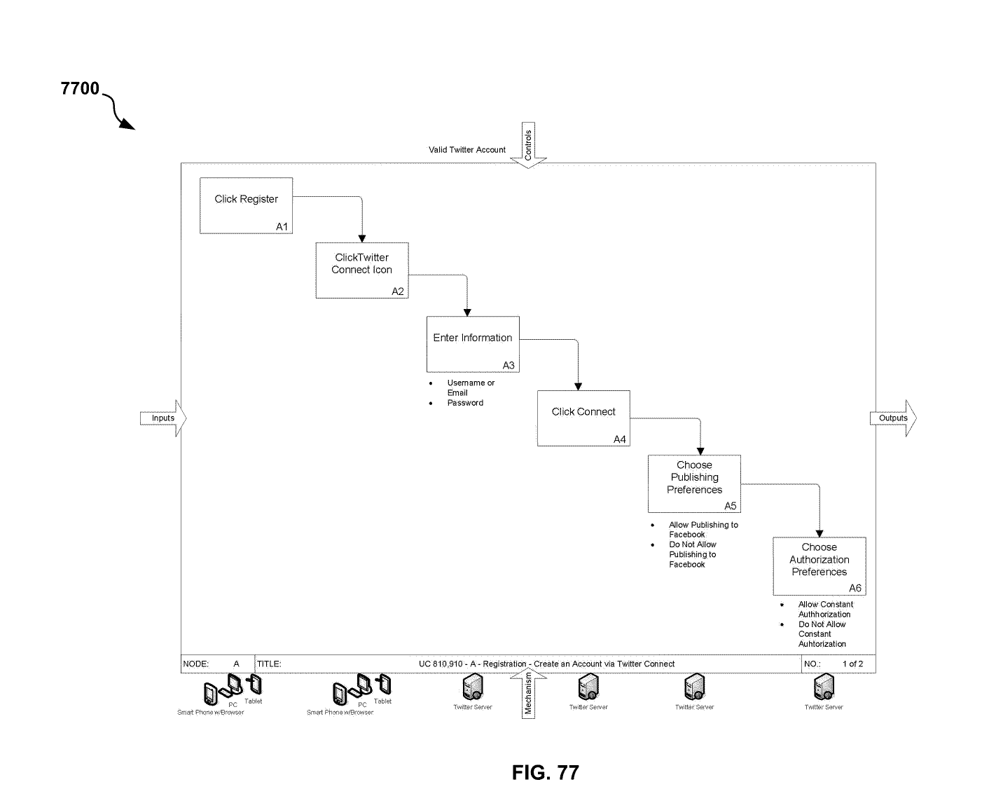

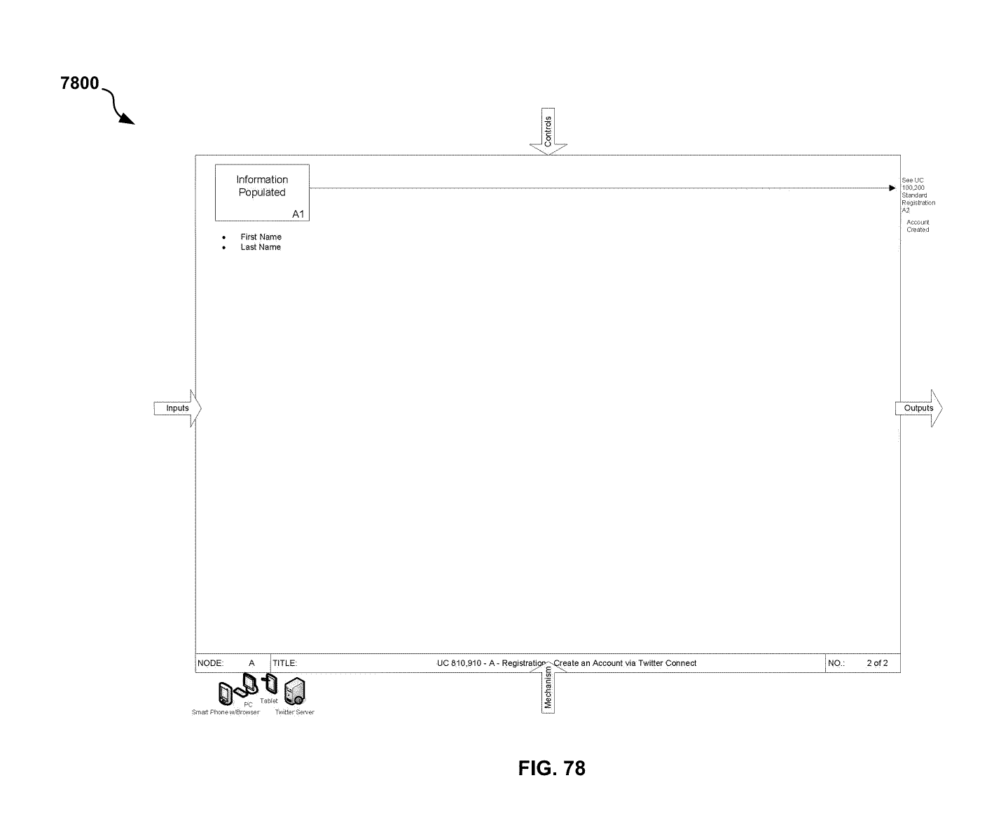

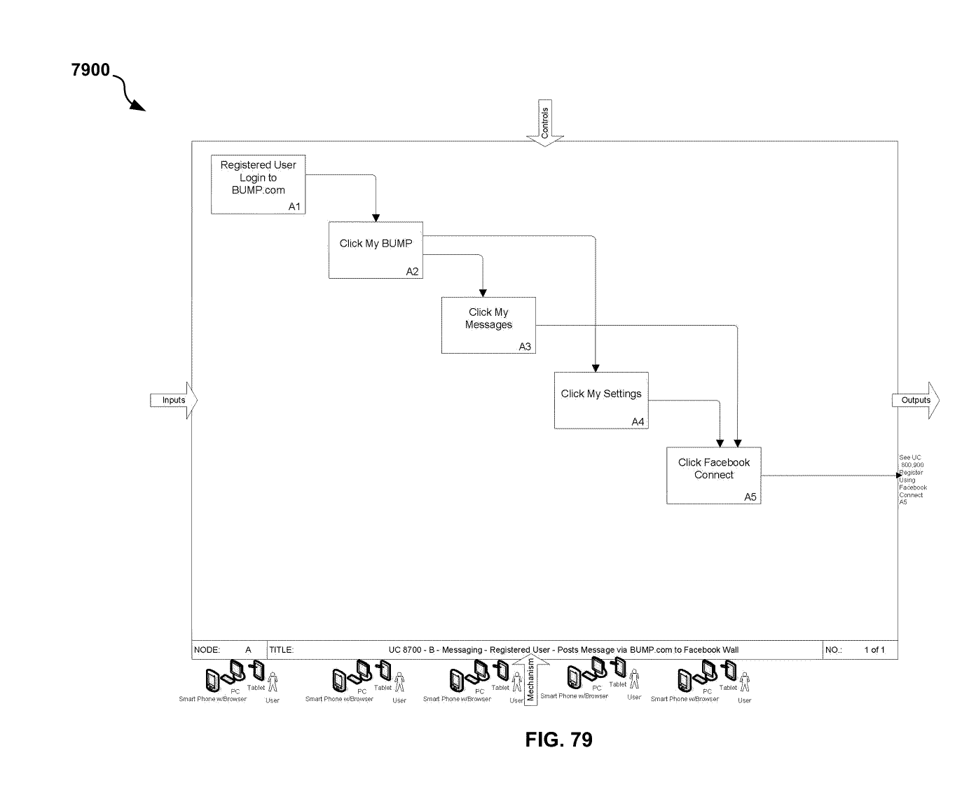

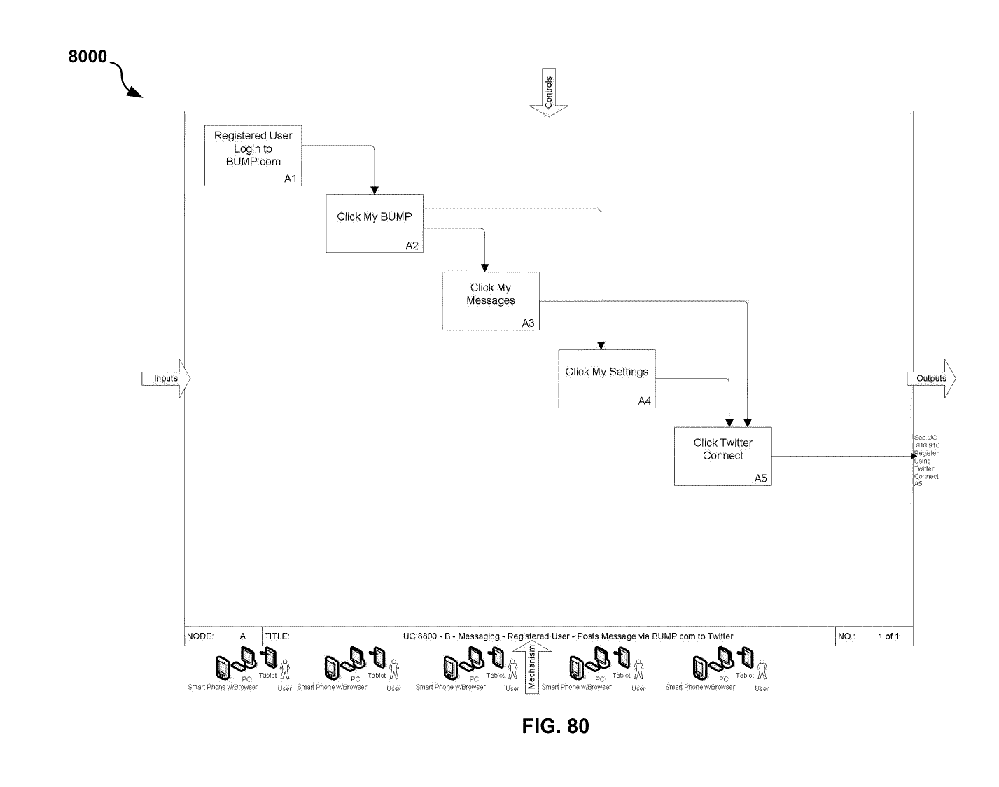

FIGS. 36-80 illustrate exemplary use cases and embodiments of exemplary processing infrastructure capable of facilitating the corresponding user interaction.

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein. It is intended that the following claims and their equivalents define the scope of the disclosure.

We claim:

1. A method for facilitating user interaction, the method comprising:
receiving, at a first user device, identification information associated with a targeted user;
sending a request to communicate with the targeted user wherein the request includes the identification information; and
receiving, responsive to the request, contact information associated with the targeted user.

2. The method of claim 1, wherein the identification information includes a license or registration number.

3. The method of claim 2, wherein the identification information further includes a jurisdiction associated with the license or registration number.

4. The method of claim 3, wherein the jurisdiction is a state.

5. The method of claim 3, wherein the jurisdiction is a province.

6. The method of claim 3, wherein the jurisdiction is a district.

7. The method of claim 3, wherein the jurisdiction is a country or region.

8. The method of claim 1, wherein the identification information includes license or registration plate information and the receiving includes capturing an image or video of a license or registration plate associated with the targeted user.

9. The method of claim 8, wherein the sending a request includes sending the image or video of the license or registration plate.

10. The method of claim 1 further comprising sending, based upon the contact information, a message to a second user device associated with the targeted user.

11. The method of claim 10, wherein the message is an email message.

12. The method of claim 10, wherein the message is a text message.

13. The method of claim 10, wherein the message is a voice message.

14. The method of claim 1, wherein the contact information includes an electronic address of the second user device.

15. The method of claim 1, wherein the contact information includes a phone number of the second user device.

16. A computer program product comprising a computer-readable medium including codes for causing a computer to:
receive identification information corresponding to a targeted user
send a request to communicate with the targeted user wherein the request includes the identification information; and
receive, responsive to the request, contact information associated with the targeted user.

17. A communications device, comprising:
a processing module configured to receive identification information corresponding to a targeted user;
a transmitter module configured to send a request to communicate with the targeted user wherein the request includes the identification information; and
a receiver module configured to receive, responsive to the request, contact information associated with the targeted user.

18. A method for facilitating user interaction, the method comprising:
receiving, from a first user device, identification information associated with a targeted user;
retrieving, from a database, contact information associated with the identification information; and
providing the contact information to the first user device.

19. The method of claim 18, wherein the identification information includes a license or registration number.

20. The method of claim 19, wherein the identification information further includes jurisdiction information associated with the license or registration number.

21. The method of claim 20, wherein the jurisdiction information identifies a state.

22. The method of claim 20, wherein the jurisdiction information identifies a province.

23. The method of claim 20, wherein the jurisdiction information identifies a district.

24. The method of claim 20, wherein the jurisdiction information identifies a country or region.

25. The method of claim 18, wherein the identification information includes an image or video of a license or registration plate associated with the targeted user.

26. The method of claim 18 wherein the providing includes sending a message to the first user device.

27. The method of claim 26, wherein the message is an email message.

28. The method of claim 26, wherein the message is a text message.

29. The method of claim 26, wherein the message is a voice message.

30. The method of claim 18, wherein the contact information includes an email address.

31. The method of claim 18, wherein the contact information includes a phone number.

32. The method of claim 18 further including sending, to a second user device associated with the targeted user, a message relating to establishing communication with the first user device.

33. The method of claim 18 further including sending, to a second user device associated with the targeted user, information associated with the first user.

34. The method of claim 33 wherein the information associated with the first user includes a phone number.

35. The method of claim 33 wherein the information associated with the first user includes an electronic address.

36. A computer program product comprising a computer-readable medium including codes for causing a computer to:
receive, from a first user device, identification information associated with a targeted user;
retrieve, from a database, contact information associated with the identification information; and
provide the contact information to the first user device.

37. The computer program product of claim 36 wherein the codes further include codes for sending, to a second user device associated with the targeted user, information relating to establishment of communication with first user device.

38. A system for facilitating user interaction, comprising:
a receiver module configured to receive, from a first user device, identification information associated with a targeted user;
a processor module configured to search a database for contact information associated with the identification information; and
an output module configured to provide the contact information to the first user device.

39. The system of claim 38 wherein the output module is further configured to send, to a second user device associated with the targeted user, information relating to establishment of communication with the first user device.
